(19) United States
(12) Patent Application Publication
(10) Pub. No.: US 2005/0009687 A1
(43) Pub. Date: Jan. 13, 2005

(54) Titanium alkoxide catalysts for polymerization of cyclic esters and methods of polymerization

(76) Inventors: John G. Verkade, Ames, IA (US); Jnaneshwara Ganesh Kindel, Mangalore (IN)

Correspondence Address: Schwegman, Lundberg, Woessner & Kluth, P.A., P.O. Box 2938, Minneapolis, MN, 55402, US

(21) Appl. No.: 10/837,257

(22) Filed: Apr. 30, 2004

Related U.S. Application Data
(60) Provisional application No. 60/467,435, filed on May 2, 2003.

(51) Int. Cl. C08G 63/82; B01J 23/00; B01J 25/00; B01J 29/00

(52) U.S. Cl. 502/100; 502/200; 528/357

(57) ABSTRACT

Titanium alkoxide catalysts for polymerization of cyclic esters such as LA and CL and methods of polymerization are disclosed. Titanium is known to be non-toxic and the various compounds described herein can catalyze cyclic esters to produce polyesters with controlled molecular weights and relatively narrow molecular weight distributions. In one embodiment, caged titanium alkoxides catalysts are used. The caged titanium alkoxides can be atranes or non-atranes.

### RELATED APPLICATIONS

This application claims the benefit under 35 U.S.C. 119(e) of U.S. Provisional Patent Application No. 60/467,435, filed May 2, 2003, which is hereby incorporated by reference.

### STATEMENT OF GOVERNMENT RIGHTS

This invention was made with Government support under NSF Contract No. 9905354. The United States Government has certain rights in this invention.

### FIELD

The invention relates to catalysts and methods and more particularly to titanium alkoxide catalysts for polymerization of cyclic esters and methods of polymerization.

### BACKGROUND

Cyclic esters, i.e., lactones, include many different types of compounds, such as lactide (LA) and e-caprolactone (CL). Polymerization of such compounds is known to produce useful products. For example, polylactide (PLA) polymers are biodegradable renewable materials that are proving to be valuable in many applications, including, but not limited to, packaging films, diapers, paper coatings, and a variety of medical implant devices including matrices for the slow release of pharmaceuticals.

The ring opening polymerization (ROP) of certain cyclic esters, such as LA and CL, with metal complexes, has been intensively studied over the past few decades. Various metal alkoxides have been found to be cyclic ester polymerization catalysts. However, some of these catalysts contain components considered to be toxic.

What is needed, therefore, are new types of catalysts capable of polymerizing cyclic esters which are efficient and non-toxic.

### SUMMARY

Titanium alkoxide catalysts for polymerization of cyclic esters such as LA and CL and methods of polymerization are disclosed. Titanium is known to be non-toxic and the various compounds described herein can catalyze cyclic esters to produce polyesters with controlled molecular weights and relatively narrow molecular weight distributions. In one embodiment isotactic polyesters are produced. In another embodiment heterotactic or atactic polyesters are produced.

In one embodiment, the titanium alkoxide catalysts are non-caged compounds utilizing titanium (IV) (hereinafter “Ti(IV)”). In one embodiment the non-caged compounds are selected from the group consisting of titanium(IV) tetrakis-isopropoxide, chlorotitanium(IV) tris-isopropoxide and dichlorotitanium(IV) bis-isopropoxide.

In one embodiment, the non-caged alkoxide catalyst is trichlorotitanium isopropoxide. In another embodiment, one to three chlorines of the trichlorotitanium isopropoxide compound are replaced by one to three donor amido groups NRR′ or alkoxy groups OR, a tridentate amido ligand such as RC(CH₂NR′)₃, or a tridentate alkoxy ligand of the type RC(CH₂O)₃, wherein R and R′ are selected from the group consisting of H and C₁-C₁₆, cyclics (including alicyclics, aromatics or heterocyclics) and substituted cyclics.

In another embodiment, the non-caged or acyclic titanium alkoxide catalysts are catalysts having a C₅H₅ ring and three isopropoxide groups. In a particular embodiment, cyclopentadienyltitanium tris-isopropoxide, such as cyclopentadienyltitanium(IV) tris-isopropoxide is used. In another embodiment, one or two of the isopropoxide groups of the cyclopentadienyltitanium tris-isopropoxide compound are replaced with another suitable electron density donor, such as a chloride, or any type of amido group (including two amido groups connected to form a chelate ring), or a bidentate O(CR₂)ₓO group wherein x=2 or 3 and R is selected from the group consisting of H and C₁- C₅. Alternatively or additionally, in another embodiment, the C₅H₅ ring in such a compound can have one to five R groups attached wherein R is selected from the group consisting of H, C₁- C₅, one or more aryl groups and combinations thereof. In one embodiment, the compound contains two chlorines, a methoxide or isopropoxide and a C₅H₅ ring.

In another embodiment, the compounds are caged compounds, such as caged Ti(IV) compounds that are either atranes (possessing electron donation from the bridgehead nitrogen) or non-atranes. In one embodiment, the caged compounds contain at least one 6-membered ring. In a particular embodiment the 6-membered ring is comprised of a benzyl or substituted benzyl ring, a titanium(IV) and a nitrogen or oxygen. In another embodiment, the caged compounds contain at least one 5-membered ring. In other embodiments, various combinations of 5- and 6-membered rings can be used.

In one embodiment the caged titanium alkoxide compound is a type of atrane known as a titanatrane. Titanatranes are normally defined as compounds having only five-membered rings, but are considered herein to also include compounds having six-membered rings, i.e., “expanded ring titanatranes,” as well as compounds in which only some of the rings are expanded, i.e., a “partially-expanded ring titanatrane,” e.g., a ⅓ expanded ring titanatrane containing, for example, the nitrilo(2-oxy-3,5-dimethylbenzyl)diethanoxy ligand or a ⅔ expanded ring titanatrane containing, for example, the nitrilo-bis(2-oxy-3,5-dimethylbenzyl)ethanoxy ligand.

It is understood that any of a variety of axial substituents can be present on the titanium including, but not limited to alkoxy groups (e.g. methoxy through at least decoxy), aryloxy groups, and the like. In one embodiment, the titanium alkoxide titanatrane is an isopropoxy derivative, such as isopropoxytitanatrane.

In one embodiment the titanatrane compound contains a fused second ring structure connected to an oxygen atom, which in turn is connected to the titanium atom. In one embodiment, the compound contains a benzyl or substituted benzyl ring with an R group wherein R is selected from the group consisting of H, C₁-C₅, one or more aryl groups and combinations thereof, connected to the benzyl ring at any location, wherein the benzyl ring is connected to an oxygen atom, which in turn is connected to the titanium atom.

In one embodiment, the catalyst is a novel titanatrane compound having a nitrilo-tris-(aryloxy) group connected to a titanium atom. In one embodiment the nitrilo-tris-(aryloxy) group is a phenyl group. In another embodiment, the nitrilo-tris-(aryloxy) group possesses an electron withdrawing group or even an electron neutral group. In a particular embodiment, the catalyst is a novel compound selected from the group consisting of phenoxytitanatrane, tetrafluorophenoxytitanatrane, paranitrophenoxytitanatrane and 2,4,6-trimethylphenoxytitanatrane.

In another embodiment, a pinacolyloxy compound is attached to each of two titanatranes. In a particular embodiment, pinacolyloxy-bis-titanatrane is used as a catalyst.

In one embodiment the titanatrane compound further includes more than one benzene ring. The actual number of benzene rings is limited only by the number of C—C—O links bridging the nitrogen and the titanium. In a particular embodiment, 2,2′,2″-nitrilotriphenolato)titanium isopropoxide, having three benzene rings, is used.

In one embodiment, the titanatrane catalyst is an expanded ring titanatrane having any suitable type of alkoxy group attached (e.g., methoxy, ethoxy, isopropoxy, n-propoxy, up through at least decoxy). In one embodiment, the expanded ring titanatrane further contains a benzyl ring or a substituted benzyl ring having an R group attached at any location, wherein R is selected from the group consisting of H, C₁-C₅, one or more aryl groups and combinations thereof. In another embodiment, there is a second R group connected to the methylene of the benzyl group, wherein the second R is selected from the group consisting of H, C₁-C₅, one or more aryl groups and combinations thereof. In a particular embodiment, the expanded ring titanatrane compound is 2,2′2″-nitrilo-tris(2-methylenyl-4,6-dimethylphenolato)titanium isopropoxide. In a particular embodiment, the titanatrane compound is a novel expanded ring titanatrane compound having the formula 2,2′2″-nitrilo-tris(2-methylenyl-4-methyl-6-tertiarybutylphenolato)titanium isopropoxide.

In yet another embodiment, the titanatrane compound is a novel compound having the formula: 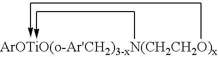
(Ar=2,6-di-i-Pr-phenoxy; Ar′=2,4-di-MeC₆H₂; x=0-3, featuring up to three six-membered chelating rings or up to three five-membered chelating rings, which can include titanatranes, expanded ring titanatranes, ⅓ expanded ring titanatranes, ⅔ expanded ring titanatranes, and the like. In a specific embodiment, the titanatranes are selected from the group consisting of nitrilo-tris(2-hydroxy-3,5-dimethylbenzyl)titanatrane (expanded ring titanatrane), nitrilo-bis(2-hydroxy-3,5-dimethylbenzyl)ethoxytitanatrane (⅔ expanded ring titanatrane), nitrilo-(2-hydroxy-3,5-dimethylbenzyl)diethoxy titanatrane (⅓ expanded ring titanatrane) and nitrilotriethoxy titanatrane (conventional titanatrane).

In another embodiment, the non-atrane caged catalysts used are trinuclear titanium complexes, i.e., trititanium clusters, including novel trinuclear titanium complexes. In one embodiment the novel trinuclear titanium complexes have any pair of suitable types of tris(2-oxyphenyl)methane ligands and six alkoxy groups (e.g. methoxy through at least pentoxy) or any aryl group (e.g., substituted phenyl) attached. In one embodiment, the tris(2-oxyphenyl)methane can be substituted with alkyl or aryl groups on the benzene rings or on the methine carbon. In a specific embodiment, Ti₃[tris(2-oxy-3,5 dimethylphenyl)methane]₂(O-i-Pr)6 is used as the catalyst.

In another embodiment, the non-atrane caged catalysts used are tetranuclear titanium complexes, i.e., tetratitanium clusters, including novel tetranuclear titanium complexes. In one embodiment the novel tetranuclear titanium complexes have any suitable type of two RC(CR′₂O)₃ groups (wherein R and R′ are selected from the group consisting of H, C₁-C₅ and aryl groups)and ten OR″ groups, wherein R″ is one or more alkoxy groups (e.g. methoxy through at least pentoxy) or any aryl group (e.g., substituted phenyl). In a specific embodiment, bis1,1,1-trimethylene-oxy ethane deca-isopropoxy tetratitanium is used as the catalyst.

In other embodiments, other atranes and expanded ring atranes of metals of groups 4 and 6-12 of the Periodic Table can be used as catalysts. Such catalysts could have metal oxidation state less than +4 and contain ligating groups such as, but not restricted to, those shown in the examples below. Such compounds may also function as catalysts for the polymerization of alkenes.

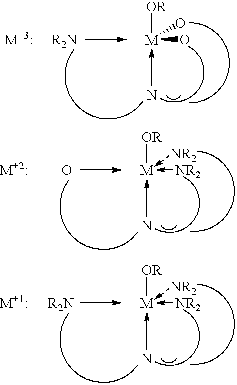

In yet other embodiments, atranes and expanded ring atranes of metals of group 4 and 6-12 of the Periodic Table may also be made to possess chirality so as to induce chirality in the polyester polymers made from chiral cyclic esters. Such compounds include, but are not limited to, the examples below which are not intended to be limiting as to the number or location of the chiral groups or the oxidation state of the metal implied in the structures below:

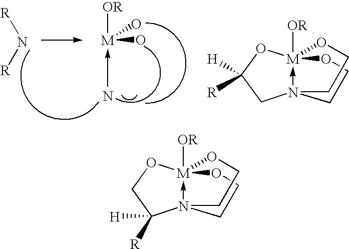

In one embodiment, the polymerization method used to polymerize a cyclic ester in the presence of a titanium alkoxide catalyst is bulk polymerization. In another embodiment the polymerization method is solution polymerization, although the invention is not so limited. (Typical solvents used in solution polymerization include, but are not limited to toluene, methylene chloride, tetrahydrofuran, and the like). Other types of polymerization methods can also be used, including, but not limited to, suspension polymerization, emulsion polymerization, and the like, although such methods typically require additional steps. In general, however, it is understood that such polymerizations are living or ionic polymerizations.

In general, the conditions under which polymerization occurs need to be from about zero (0) to 200 ° C. for bulk polymerization and from zero (0) ° C. to the boiling point of the solvent for solution polymerization.

In one embodiment, the present invention provides novel synthesis routes for producing the novel compounds described herein.

The catalysts described herein are capable of polymerizing various cyclic esters under a range of conditions as described herein. Although it may be possible to use any type of polymerization method, bulk polymerization may ultimately prove to be more feasible commercially since no solvent is required, thus saving steps and reducing costs.

### BRIEF DESCRIPTION OF THE DRAWINGS

FIG. 1 is an Oak Ridge (Molecular Lab) Thermal Ellipsoid Program (Molecular Modeling) (ORTEP) drawing of tetrafluorophenoxytitanatrane (Compound 7 in Example 1) showing 50% probability thermal ellipsoids with H atoms and solvent omitted for clarity in an embodiment of the present invention.

FIG. 2 shows the methine region of the homonuclear decoupled ¹H-NMR spectra for poly(rac-LA) produced by (a) titanium tetrakis-isopropoxide (b) chlorotitanium tris-isopropoxide (c) dichlorotitanium bis-isopropoxide and (d) trichlorotitanium isopropoxide (compounds 14 in Example 1) under bulk polymerization conditions in embodiments of the present invention.

FIG. 3 shows the methine region of the homonuclear decoupled ¹H-NMR spectra for poly(rac-LA) produced by the compounds of FIG. 3 under solution polymerization conditions in embodiments of the present invention.

FIG. 4 is a plot of Mn and PDI values (employing polystyrene standards) for PLA as a function of bulk or solution polymerization time at 70° C. in toluene with [LA]/[Ti]=200 using chlorotitanium tris-isopropoxide (compound 2 in Example 1) as the catalyst in an embodiment of the present invention.

FIG. 5 shows GPC traces of isolated PLA produced with chlorotitanium tris-isopropoxide (compound 2 in Example 1) ([LA]/[Ti]=200) at (a) 4 hr, (b) 16 hr, (c) 20 hr, (d) 24 hr and (e) 36 hr, with PDI values of 1.10, 1.06, 1.08, 1.10 and 1. 12, respectively, in embodiments of the present invention.

FIG. 6 shows the ¹H NMR spectrum of PCL synthesized in toluene at 70° C. along with a typical GPC trace (PDI=1.06) in an embodiment of the present invention.

FIG. 7 is a plot of Mn and PDI values (employing polystyrene standards) for PLA as a function of [LA]/[Ti] at 70° C. in toluene using isopropoxytitanatrane (Compound 5 in Example 1) as the catalyst in embodiments of the present invention.

FIG. 8 shows GPC traces of PLA samples produced with isopropoxytitanatrane (Compound 5 in Example 1) as the catalyst at (a) [LA]/[Ti]=40, (b) 120, (c) 150, (d) 180 and (e) 400, with PDI values of 1.10, 1.19, 1.06, 1.07 and 1.15, respectively, in embodiments of the present invention.

FIG. 9 shows variable temperature ¹H NMR spectra of nitrilo-tris(2-hydroxy-3,5-dimethylbenzyl)titanatrane (Compound 5 in Example 2).

FIG. 10 is an ORTEP drawing of the compound of FIG. 9 showing 50% probability thermal ellipsoids with H atoms and solvent omitted for clarity in an embodiment of the present invention.

FIG. 11 is an ORTEP drawing of nitrilo-bis(2-hydroxy-3,5-dimethylbenzyl)ethanoxytitatanatrane (Compound 6 in Example 2) showing 50% probability thermal ellipsoids with H atoms and solvent omitted for clarity, in an embodiment of the invention.

FIG. 12A shows an ORTEP drawing of the solid state molecular structure of Ti₃[tris(2-oxy-3,5-dimethylphenyl)methane]₂(O-i-Pr)₆ (Compound 2(ss) in Example 3) showing 50% probability thermal ellipsoids with H atoms omitted for clarity, in an embodiment of the invention.

FIG. 12B shows thermal ellipsoids of the central core for the compound of FIG. 12A with carbon and hydrogen atoms having been removed for clarity, in an embodiment of the invention.

FIG. 13 is a ¹H NMR spectrum of (Compound 2 in Example 3) in benzene-d₆ as a function of time in an embodiment of the invention.

FIG. 14 is a plot of Mn (open squares, GPC) vs. monomer conversion (determined by ¹H NMR spectroscopy), with polydispersity indices indicated by open circles (GPC) in the presence of the compound of FIG. 13 in embodiments of the invention.

FIG. 15 is a ¹H NMR spectrum for 1,1,1-trimethylene-oxy propane isopropoxy tetranuclear titanium alkoxide (Compound 1 in Example 4) in an embodiment of the invention.

FIG. 16 is a plot of Mₙ (upper line) and PDI (lower line) vs polystyrene standards for PLA as a function of [LA]/[Ti] at 70° C. in toluene in the presence of the compound of FIG. 15.

### DETAILED DESCRIPTION OF THE EMBODIMENTS

In the following detailed description, embodiments are described in sufficient detail to enable those skilled in the art to practice the invention. Other embodiments may be utilized and structural, logical and other changes may be made without departing from the spirit and scope of the present invention. The following detailed description is, therefore, not to be taken in a limiting sense.

Various caged and non-caged titanium alkoxides were synthesized and tested as possible catalysts for the polymerization of certain cyclic esters using both bulk and solution polymerization. The caged compounds include atranes, including expanded atranes, as well as non-atranes. It is to be understood, however, that other catalysts in this group as well as other polymerization methods are possible, including, but not limited to, emulsion and suspension polymerization, etc. When used without qualification, the term “polymerization” is intended to include all types of polymerization and is generally understood to refer to a “living polymerization.”

When used without qualification, the polymers produced herein, i.e., polyesters, such as polylactides (PLA), etc., can refer to any form of the polymer, including, isotactic, atactic or heterotactic compounds. Generally an isotactic polymer (ordered methyl groups) has a higher glass transition temperature as compared with heterotactic or atactic, which may be desirable for thermal strength, although such polymers may be more difficult to process. Heterotactic polymers are less ordered and have a lower glass transition temperature, such that they are more easily processed than isotactic polymers and thus more useful in other applications. Atactic polymers have methyl groups which are even more disordered as compared with heterotactic polymers and hence a correspondingly lower glass transition temperature. Atactic polymers are generally more thermally processable for a given molecular weight.

It is further understood that all of the compounds included herein contain alkoxide groups, even though the particular name used for the compound may not necessarily make reference to this group.

In Example 1, fourteen titanium alkoxides, including both caged atrane compounds (titanatranes) and non-caged compounds, were synthesized for comparison of their catalytic properties in the bulk and solution polymerization of lactide (LA).

These compounds include: 1 titanium tetrakis-isopropoxide, 2 chlorotitanium tris-isopropoxide, 3 dichlorotitanium bis-isopropoxide, 4 trichlorotitanium isopropoxide, 5 isopropoxytitanatrane, 6 phenoxytitanatrane, 7 tetrafluorophenoxytitanatrane, 8 paranitrophenoxytitanatrane, 9 2,4,6-trimethylphenoxytitanatrane, 10 pinacolyloxy-bis-titanatrane, 11 (2,2′,2″-nitrilotriphenolato)titanium isopropoxide, 12 2,2′2″-nitrilo-tris(2-methylenyl-4,6-dimethylphenolato)titanium isopropoxide, 13 2,2′,2″-nitrilo-tris(2-methylenyl-4-methyl-6-tertiarybutylphenolato)titanium isopropoxide, and 14 cyclopentadienyltitanium tris-isopropoxide. (Numbering of these compounds corresponds with compound numbers shown immediately below and in Example 1):

The structures of these compounds are as follows:

| | 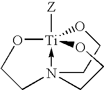 |
|---|---|
| 1 | Ti(O-i-Pr)₄ |
| 2 | TiCl(O-i-Pr)₃ |
| 3 | TiCl₂(O-i-Pr)₂ |
| 4 | TiCl₃(O-i-Pr) |
| | Z |
| 5 | O-i-Pr |
| 6 | 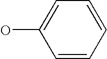 |
| 7 | 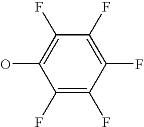 |
| 8 | 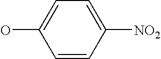 |
| 9 | 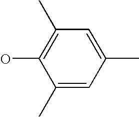 |
| 10 | 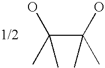 |
| 11 | 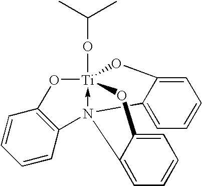 |
| 12 | 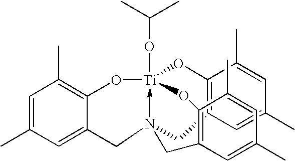 |
| 13 | 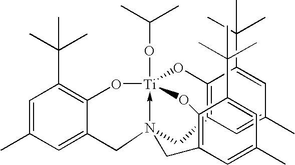 |
| 14 | 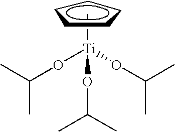 |

The “Z” ligands connected to the titanium in the titanatrane structure shown above are each connected at the oxygen in compounds 5-9. In compound 10, the Z ligand is connected to two titanatranes, with a titanatrane connected at each oxygen. All of the above catalysts were effective polymerization catalysts in terms of yield and molecular weight in bulk polymerization. The titanatranes (5-14) gave polylactides with significantly increased molecular weight over more extended polymerization times. Catalysts with five-membered ring titanatranes (i.e., 5-11) afforded polymers in higher yields and with larger molecular weights than their six-membered ring, i.e., expanded ring counterparts (i.e., 12-13). Steric hindrance of the rings was found to significantly affect polymer yields. Increased heterotactic-biased poly(rac-LA) was obtained as the number of chlorine atoms increased in the various non-caged compounds, namely, TiCl,(O-i-Pr)₄₋ₓ.

In solution polymerization, titanium alkoxides catalyzed controlled polymerizations of LA. End group analysis demonstrated that an alkoxide substituent on the titanium atom acted as the initiator. That polymerization is controlled under these conditions was shown by the linearity of molecular weight versus the [LA]/[Ti] ratio and the polymerization time. A tendency toward formation of heterotactic-biased poly(rac-LA) was observed in the solution polymerizations. The rate of ring opening polymerization (ROP) and the molecular weight of the polymers were greatly influenced by the substituents on the catalyst, and by factors such as the polymerization temperature, polymerization time and concentration of monomer and catalyst.

In Example 2, titanatrane compounds with varying ring sizes were tested. More specifically, the synthesis, characterization and catalytic ability for the bulk polymerization of LA, for four titanatranes possessing the ligands derived by deprotonation of the OH groups in 1 nitrilo-tris(2-hydroxy-3,5-dimethylbenzyl)amine, 2 nitrilo-bis(2-hydroxy-3,5-dimethylbenzyl)ethanol, 3 nitrilo-(2-hydroxy-3,5-dimethylbenzyl)diethanol and 4 triethanol are described in the reactions numbered (1)-(4) immediately below and in Example 2. (Numbering of the compounds also corresponds with compound numbers shown immediately below and in Example 2). The corresponding four titanatranes, namely, 5 nitrilo-tris(2-hydroxy-3,5-dimethylbenzyl)titanatrane, 6 nitrilo-bis(2-hydroxy-3,5-dimethylbenzyl)ethanoxy titanatrane, 7 nitrilo-(2-hydroxy-3,5-dimethylbenzyl)diethanoxytitanatrane and 8 nitrilo-triethanoxytitanatrane (as and in Example 2) all possess an axial anionic 2,6-di-i-Pr-The reactions, with corresponding numbers, include:

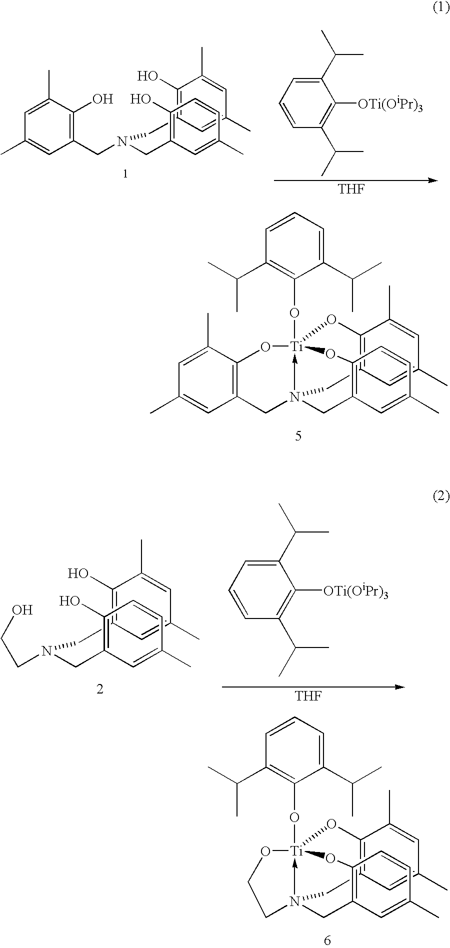

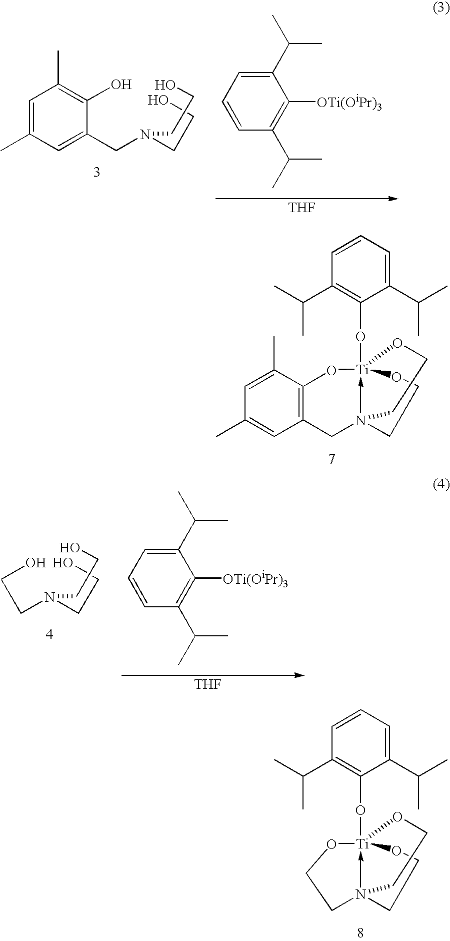

The molecular structures of 5 and 6, determined by X-ray means, revealed that in both of these complexes the transannular N—Ti bond lengths [2.305(2) Å, 5; 2.287(4) Å, 6] are at the short end of the range for titanatranes possessing three five-membered rings.

These compounds show good catalytic activity for the bulk homopolymerization of I and rac-lactide at 130° C.

Example 3 shows the synthesis of a novel caged non-atrane, namely trinuclear titanium alkoxide (compound 2 immediately below and in Example 3), its novel solution behavior, its solid state X-ray structure and its behavior as a catalyst in the living polymerization of lactide.

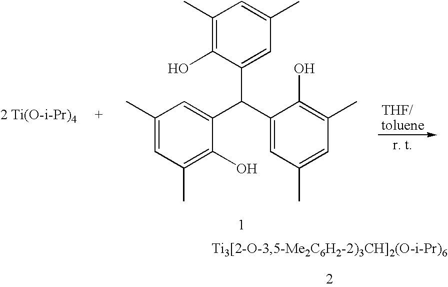

More specifically, the novel trinuclear titanium complex Ti₃[tris(2-oxy-3,5-dimethylphenyl)methane]₂(O-i-Pr)₆ with one 4-coordinated titanium(IV) center and two 5-coordinated titanium(IV) centers in the solid state was synthesized and characterized by NMR as well as by X-ray means. Somewhat surprisingly, the ¹H NMR spectrum of the initial solution structure is inconsistent with the X-ray structure, but it is consistent with two opposing tridentate trianions with an oxygen from each of which is covalently bridged by a (i-PrO)₂Ti²⁺ formal cation. Over a period of one week in a benzene-d₆ solution at room temperature, however, a novel rearrangement occurs in the presence of catalytic amounts of atmospheric or added moisture that produces a ¹H NMR spectrum entirely consistent with the solid structure. This compound is a single-site initiator for the living polymerization of l-lactide to isotactic polylactide, and it is likely that other trinuclear titanium alkoxide complexes would also work. It is also likely that these compounds are also useful in the living polymerization of other cyclic esters under other polymerization conditions such as bulk polymerization.

Molecules of type 1 above are potentially more versatile tridentate ligands than more well-known examples such as 1,1,1-tris(hydroxymethyl)ethane (THME) or cis,cis-1,3,5-cyclohexatriol (CHT) because of variations that could relatively easily be made in the substituents in the 3,5-positions of phenyl rings of 1 and the diverse binding modes known in the coordination chemistry of ligands of type 1.

Example 4 shows the results of LA polymerization with a caged non-atrane, namely, tetranuclear or tetrameric titanium alkoxide complex. In this example, (MeC(CH₂-μ₃-O)(CH₂-μ-O)₂)₂Ti₄(O-i-Pr)₁₀ catalyzed the ROP of LA in toluene solution at various polymerization temperatures, and its bulk ROP at 130° C. This compound facilitated reasonably controlled polymerization characteristics via a coordination insertion mechanism in solution, whereas the bulk polymerization products displayed somewhat broader molecular weight distributions.

(MeC(CH₂-μ₃-O)(CH₂-μ-O)₂)₂Ti₄(O-i-Pr)₁₀, shown below, is depicted in an idealized configuration. See T. J. Boyle, et al., Inorg. Chem. 1995, 34, 1110, which is hereby incorporated by reference, for a more precise structure determined by x-ray diffraction.

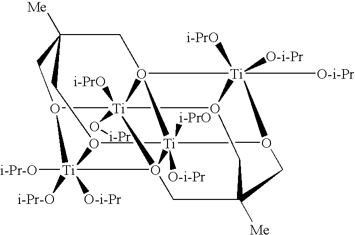

The stereochemical microstructure of the resulting PLA was determined from homonuclear decoupled ¹H NMR spectral studies. Such spectra of PLA derived from rac-LA featured the characteristic five methine resonance pattern, whereas corresponding spectra derived from l-LA exhibited only one methine peak.

For the polymers of interest herein, such as PLA, molecular weights of 25,000 to 50,000 are considered very appropriate for many uses, and it is not always necessary with polyesters to produce higher molecular weights, such as in the 100,000-200,000 range. Thus, lower molecular weight polymers are known to be useful and are industrially processable because they can be easily melted and formed. However, the higher molecular weight compounds, although useful in certain applications, are generally more difficult to thermally process.

PDI values are an indication of the uniformity of molecular weight of the various compounds. PDI values of 1.5 to 2 are routinely seen for polyester polymers and are acceptable for the vast majority of uses. For nanoscale applications, however, it is desirable to have PDI values closer to one, e.g., polymer fibers for filtering nanometer sized particulates (i.e., particles in the 10⁻⁹ meter or 10 Å range). In such applications it is preferable to have polymer fibers with lengths as even as possible, rather than of variable length (molecular weights). This is also true for molecular “bristles” (often referred to as “nano-sized brushes”).

As noted above, the atrane compounds described herein (e.g., compounds 5-13 in Example 1, compounds 5-8 in example 2), all possess electron donation from the bridgehead nitrogen. In terms of obtaining a product having a higher molecular weight, such electron donation appears to produce a surprisingly good result. Compare, for example, two catalysts of the tetraalkoxy type, such as isopropoxytitanatrane (compound 5 in Example 1) and titanium tetrakis-isopropoxide (compound 1 in Example 1) used herein in bulk polymerization. As the results in Table 1 show, isopropoxytitanatrane has better results in terms of molecular weight as compared with the titanium tetrakis-isopropoxide for bulk polymerization.

A weakened electron donation effect due to the larger size of the rings in compounds such as expanded ring titanatranes (e.g., compounds 12 and 13 in Example 1) and/or increased steric hindrance from the “picket fence” of alkyl groups near the titanium atom appear to be operating to reduce the molecular weights seen in Table I (entries 31 and 32) for these catalysts. It is interesting to note, however, that this effect did not make much difference in the molecular weights when solution polymerization was used (e.g., Table 3 in Example 1, entry I vs. entries 15-22), although the reasons for this are not clear. It is also possible that one of these two effects is also operating with the compounds of Example 2. Specifically, as one moves from compound 8 to 5 in Example 2 (See Table 3) it can be seen that the molecular weights in bulk polymerization become smaller.

Therefore, in order to obtain a higher molecular weight product, such as for PLA, it is believed that the electron donation occurring with the caged atrane compounds causes them to perform in a superior manner. This is because electron donation weakens the alkoxide-oxygen bond to the titanium so that the titanium fragment remaining after release of the alkoxide anion can be formed in higher concentration for the ring-opening reaction with the cyclic ester. Thus, there is a high concentration of catalyst sites capable of growing living polymer chains. Additionally, atranes have only one alkoxide, such as an isopropoxide, that can be liberated owing to the stabilization of the N(CH₂CH₂O)₃ moiety through chelation. This is considered beneficial, as such “single site” catalysts are known to prevent the growth of more than one chain on a catalyst molecule. As a comparison, note the “double site” bis-atrane analogue in Example 1, compound 10, which produces relatively low molecular weights. This is not to say that all multiple site catalysts are necessarily ineffective.

As noted above, however, compounds having lower molecular weights are also useful in many applications. Many examples are included herein of lower molecular weight compounds produced with various acyclic catalysts that further have a lower range PDI. For example, see compounds 3 and 4 in Example 1. It is not readily apparent why these catalysts performed so well in both bulk and solution polymerization, although it is interesting to note that both catalysts contain a halogen, namely chlorine.

Additionally, although the compounds herein are limited to containing titanium it is possible other metals of groups 4 and 6-12 of the Periodic Table may also work. However, it has been determined that certain substitutes for titanium do not provide particularly good results in terms of molecular weight and/or PDI. This includes, for example, silicon in alkoxysilatranes.

The invention will be further described by reference to the following examples which are offered to further illustrate various embodiments of the present invention. It should be understood, however, that many variations and modifications may be made while remaining within the scope of the present invention.

### EXAMPLE 1

Materials Tested

Fourteen titanium alkoxides were synthesized for comparison of their catalytic properties in the bulk and solution polymerization of lactide (LA). The strategy employed for choosing candidate titanium catalysts 1-14 shown below are that they should contain alkoxide groups and the initiating alkoxide group should dissociate relatively easily from the titanium in the early stage of polymerization so that the titanium moiety can be utilized to initiate the polymerization of LA and provide a means of controlling the molecular weight by functioning as an end group. Alkoxy titanatranes seemed well suited to these purposes since they possess a transannular Ti—N bond that could potentially labilize the trans axial OR group for dissocation.

| | 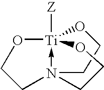 |
|---|---|
| 1 | Ti(O-i-Pr)₄ |
| 2 | TiCl(O-i-Pr)₃ |
| 3 | TiCl₂(O-i-Pr)₂ |
| 4 | TiCl₃(O-i-Pr) |
| | Z |
| 5 | O-i-Pr |
| 6 | 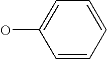 |
| 7 | 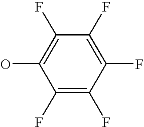 |
| 8 | 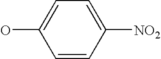 |
| 9 | 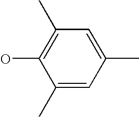 |
| 10 | 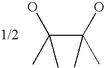 |
| 11 | 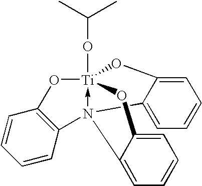 |
| 12 | 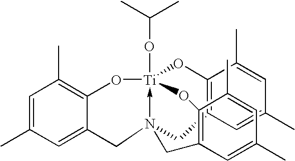 |
| 13 | 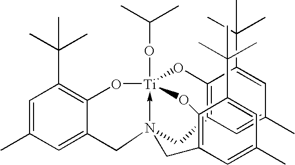 |
| 14 | 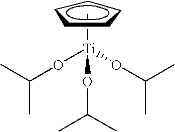 |

General Consideration

All reactions were carried out under an argon atmosphere using standard Schlenk and glove box techniques. See, for example, D. F. Shriver, The Manipulation of Air-Sensitive Compounds; McGraw-Hill: New York, 1969, hereby incorporated by reference in its entirety.

All chemicals were purchased from Aldrich and were used as supplied unless otherwise indicated. Pentane, dichioromethane, THF and toluene (Fischer HPLC grade) were dried and purified under a nitrogen atmosphere in a Grubbs-type non-hazardous two-column solvent purification system (Innovative Technologies) and were stored over activated 3 Å molecular sieves. See, for example, A. B. Pangborn, et al., Organometallics 1996, 15, 1518, hereby incorporated by reference in its entirety. All deuterium solvents were dried over activated molecular sieves (3 Å) and were used after vacuum transfer to a Schlenk tube equipped with a J. Young valve. CL was distilled under reduced pressure (90° C. /7 micron Hg pressure) from calcium hydride and stored in vacuo over 4 Å molecular sieves. l-LA and rac-LA were purified twice by sublimation at 70° C. under 7 micron Hg pressure before use.

¹H, ¹³C{¹H} and ¹⁹F-NMR spectra were recorded at ambient temperature on a Varian VXR-300 or VXR-400 NMR spectrometer using standard parameters. The chemical shifts are referenced to the peaks of residual CDCl₃ (δ 7.24, ¹H NMR; δ77.0, ¹³C{¹H} NMR) and acetone-d₆ (δ2.05, ¹H NMR). Elemental analyses were performed by Desert Analytics Laboratory in Tuscon, Arizona. Molecular weights of polymers were determined by gel permeation chromatography (GPC) and the measurements were carried out at room temperature with THF as the eluent (1 mL/min) using a Waters 510 pump, a Waters 717 Plus Autosampler, four Polymer Laboratories PL gel columns (100, 500, 10⁴, 10⁵ Å) in series, and a Wyatt Optilab DSP interferometric refractometer as a detector. The columns were calibrated with polystyrene standards.

Syntheses

5, 12, THBA (trihydroxylbenzylamine) and 14 were synthesized using literature procedures. Modified literature procedures were used for the synthesis of 2-4, 10 and 11. See, for example, Kamigaito, M. et al., Macromolecules 1995, 28, 5671; Menge, et al., Inorg. Chem. 1991, 30, 4628; Naiini, et al., Inorg. Chem. 1991, 30, 5009; Naiini, et al., Inorg. Chem. 1993, 32, 1290; Frye, C. L. Fr 1511257 (1968); Chem. Abstr. 70:59464; Chandrasekaran, A., et al., J. Am. Chem. Soc. 2000, 122, 1066; Timosheva, N. V.; et al., Organometallics 2000, 19, 5614; Timosheva, N. V et al., Organometallics 2001, 20, 2331; Kol, M. et al., Inorg. Chem. Commun. 2001, 4, 177; Harlow, R. L. Acta Crystallogr. 1983, C39, 1344; Kucht, A, et al., Organometallics 1993, 12, 3075, all hereby incorporated by reference in their entirety. Compound 13, a novel compound, was made by a new procedure as described herein. (Note: Compound 1 was purchased from Aldrich).

In the case of 2-4, pentane and a shortened reaction time (1 hr) was used. Compound 10 was obtained by a reaction between 5 and pinacol at room temperature instead of the reaction between Et₂NTi(OCH₂CH₂)₃N with pinacol. Compound 11 was synthesized by mixing Ti(O-i-Pr)₄ and THA in dichloromethane instead of THF. Compounds 7-9 were made by procedures analogous to both of those given below for 6.

Synthesis of2-4 and 14

Except for minor modifications, compounds 2-4 were obtained by the reaction of 1 with the appropriate amount of TiCl₄ in pentane at room temperature. See Kamigaito, supra. Unlike slightly viscous 2, compounds 3 and 4 precipitated as white solids within 20 minutes after combination of the reactants. To avoid generation of by products and mixtures of 2-4, a solution of TiCl₄ in dry pentane was added dropwise to exactly the appropriate number of equivalents of 1 in pentane while stirring rapidly at room temperature for I0 min. After washing thoroughly with cold pentane, these titanium compounds were used as catalysts for making PLA or as starting materials for other titanium alkoxides. Compounds 2-4 were soluble in toluene, dichloromethane and ether. Displacement of the chloride from 2 with CpNa in toluene gave the desired product 14 as a reddish-yellow oil.

Synthesis of 6-9

In this example, titanatranes 6-9 were synthesized in very good yield in a one-pot reaction containing Ti(O-i-Pr)₄, nitrilo-triethanol and the appropriate phenol. These compounds were also synthesized by a two-step reaction in which 5 is made from Ti(O-i-Pr)₄ and nitrilo-triethanol, followed by reaction with the corresponding phenol. However, yields were lower than from a one-pot reaction. Although 6 and 9 showed good solubilities, 7 and 8 displayed limited solubility in a wide variety of solvents. In spite of the limited solubility of 7 and 8, these compounds were isolated in analytically pure form. It has previously been shown that 10 could be synthesized in 70% overall yield by reacting two equivalents of (diethylamino)titanatrane with one equivalent of pinacol starting from tetrakis(diethylamino)titanium and nitrilo-triethanol. See Menge, Naiini, 1991 and Naiini, 1993, supra. However, it has now been determined that the reaction between two equivalents of 5 and one equivalent of pinacol at room temperature can generate 10 in an overall yield of 84% with a starting material (5) that is less expensive than tetrakis(diethylamino)titanium. The description of the synthesis of 6 is below. Again, compounds 7-9 were made by procedures analogous to both of those given for 6.

Synthesis of 6

Method 1: In a 250 mL Schlenk flask containing a stirring bar, phenol (0.471 g, 5.00 mmol), nitrilo-triethanol (0.746 g, 5.00 mmol) and 1 (1.42 g, 5.00 mmol) were charged in the order given. Then 50 mL of THF was added and the reaction mixture was refluxed overnight. After cooling to room temperature, volatiles were evaporated under vacuum, leaving an orange-yellow solid to which was added 15 mL of toluene. The orange solution was filtered and the desired product 6 was isolated as orange-yellow crystals after the solution remained at −15° C. in a refrigerator for several days (1.21 g, 84%). ¹H NMR (CDCl₃, 400.147 MHz): δ 7.13 (t, J=7.4 Hz, 2H, aryl-H), 7.01 (s, 1H, aryl-H), 6.76 (t, J=6.6 Hz, 2H, aryl-H), 4.60 (br s, 6H, CH₂O), 3.27 (br s, 6H, NCH₂). ¹³C{¹H} NMR (CDCl₃, 100.626 MHz): δ 165.0, 128.7, 119.5, 119.0, 129.4 (aryl), 72.43 (CH₂O), 61.10 (NCH2). Elemental Analysis Calculated (hereinafter “Elemental Anal. Calcd”) for C₁₂H₁₇NO₄Ti: C, 50.20 H, 5.97; N, 4.88. Found C, 49.15; H, 6.14; N, 5.13.

Method 2: To a solution of nitrilo-triethanol (0.746 g, 5.00 mmol) in 10 mL of THF was added dropwise at room temperature a solution of 1 (1.42 g, 5.00 mmol) in 10 mL of THF. After stirring overnight at room temperature, all volatiles were evaporated under vacuum, leaving a yellow solid 5 (1.19 g, 94%). To a THF solution of 5 (1.00 g, 3.95 mmol) in 10 mL of THF was added dropwise at room temperature a solution of phenol (0.371 g, 3.95 mmol) in 10 mL of THF. The reaction mixture was refluxed overnight and then the volatiles were evaporated under vacuum, leaving an orange-yellow solid, to which was added 15 mL of toluene. The orange solution was filtered and the desired product 6 was isolated as orange-yellow crystals after the solution remained at −15° C. in a refrigerator for several days. Yield=62% (0.62 g).

7: Colorless crystals. Yield, 90% (method 1), 66% (method 2). ¹H NMR (CDCl₃, 400.147 MHz): δ 4.72 (br s, 6H, CH₂O), 3.44 (br s, 6H, NCH₂). ¹⁹F NMR (CDCl₃, 376.479 MHz): δ-9.74 (s, 2F), -14.05 (s, 2F), δ-20.43 (s, 2F). ¹³C{¹H} NMR (CDCl₃, 100.626 MHz): δ 74.37 (CH20), 62.01 (CH₂N). Aromatic carbons could not be observed due to the low solubility of 7 in CDCl₃. Elemental Anal. Calcd for C₁₂H₁₂F₅NO₄Ti: C, 38.22; H, 3.21; N, 3.75. Found C, 38.35; H, 3.08; N, 3.75.

8: Yellow powder. Yield, 88% (method 1), 61% (method 2). 1H NMR (acetone-d₆, 400.147 MHz): δ 8.13 (d, J=11 Hz, 2H, aryl-H), 7.01 (d, J=12 Hz, 2H, aryl-H), 4.62 (br s, 6H, CH₂O), 3.49 (br s, 6H, NCH₂). Elemental Anal. Calcd for C₁₂H₁₆N₂O₆Ti: C, 43.39; H, 4.86; N, 8.43. Found C, 43.40; H, 5.22; N, 8.30.

9: Yellow crystals. Yield, 81% (method 1), 56% (method 2). 1H NMR (CDCl₃, 400.147 MHz): δ 6.70 (s, 2H, aryl-H), 4.51 (t, J=5.6 Hz, 6H, CH₂O), 3.25 (t, J=5.6 Hz, 6H, NCH₂), 2.31 (s, 6H, aryl-Me), 2.17 (s, 3H, aryl-Me). ¹³C{¹H} NMR (CDCl₃, 100.626 MHz): δ 160.3, 128.9, 128.0, 127.0 (aryl), 71.20 (CH₂O), 57.00 (CH₂N), 20.65, 17.02 (aryl-Me). Elemental Anal. Calcd for C₁₅H₂₃NO₄Ti: C, 54.72; H, 7.04; N, 4.36. Found C, 54.49; H, 7.67; N, 4.36.

Synthesis of 11-13

An attempt to first synthesize 11, 12 and 13 by transesterifying 1 with the tris-phenols nitrilo-tris(2-hydroxyphenyl)amine (2,2′,2″-nitrilotriphenol, THA), nitrilo-tris(2-hydroxy-3,5-dimethylbenzyl)amine (THDA) and nitrilo-tris(2-hydroxy-3-tert-butyl-5-methylbenzyl)amine (THBA), respectively, was made. However, 11-13 obtained in this manner were contaminated with i-PrOH despite extended drying under vacuum. For example, 11 consistently retained 0.5 equivalents of i-PrOH after several recrystallizations from THF/toluene. In searching for a new synthetic route to 11-13, 4 were chosen as the starting material. It was anticipated that the reaction of 4 with THDA in the presence of triethylamine under mild conditions could involve chloride displacement from the metal by THDA. This prediction was based on a somewhat lower Ti—Cl bond dissociation energy (430 kJ/mol for TiCl₄,) compared with the analogous value for the Ti-O-i-Pr bond [444 kJ/mol for Ti(O-i-Pr)₄ ]. However, the product obtained in the reaction of 4 with THDA was the corresponding chlorotitanatrane, which is known to form in the reaction of CpTiCl₃ with THDA wherein the η⁵-Cp ligand is displaced. Thus, 12 was synthesized in high yield by reacting 14 with THDA, a known reaction that also occurs by displacement of a η⁵-Cp ligand. The C₅—Ti bond dissociation energy associated with the η⁵-Cp—Ti moiety is 335 kJ/mol [an interpolated value between that of η⁵-CpTiCl₃ and (η⁵-Cp)₂TiCl₂]. The leaving ability of these groups in their displacement by THDA decreases in the order Cp>O-i-Pr>Cl in which the last two members appear reversed considering only the bond dissociation energies involved. Because the difference between these latter two energies is only about 3%, greater relief of steric strain by departure of an O-i-Pr compared with that of a Cl substituent may dominate their leaving ability order. Compounds 11 and 13 were made starting from 1. All the compounds evaluated as catalysts in the present work were pre-purified by recrystallization or distillation.

Synthesis of N[CH₂(Bu^{t}MeC₆H₂)O]₃TiOⁱPr (13)

A solution of 1 (5 mmol, 1.42 g) in dichloromethane (30 mL) was added to a solution of THBA (5 mmol, 2.73 g) in dichloromethane (40 mL) with stirring at room temperature over a period of 10 min and then the solution was stirred for an additional 14 hr. The solvent was removed from this solution in vacuo and the residue was re-crystallized from a dichloromethane/hexane (1:2, 30 mL). The yellowish crystalline product 13 was washed with cold pentane and dried (Yield: 2.76 g, 85.2% before recrystallization, yield: 2.12 g, 65.4% after recrystallization). MP, 366-368° C. ¹H NMR (299.94 MHz, CDCl₃, ppm): 8 6.95 (d, J=1.7 Hz, 1H, aryl), 6.74 (d, J=1.5 Hz, 1H, aryl), 5.20 (m, 1H, OCHMe₂), 3.93 (d, J=13 Hz, 3H, NCH₂), 2.82 (d, J=13 Hz, 3H, NCH₂), 2.24 (s, 9H, aryl-Me), 1.49 (d, J=6.1 Hz, 6H, OCHMe₂), 1.42 (s, 27H, tert-butyl). ¹³C{¹H} NMR (75.43MHz, CDCl₃, ppm): δ 160.5, 135.7, 128.8, 127.9, 126.6, 124.8 (aryl), 79.53 (CHMe₂), 58.40 (NCH₂), 34.72 (CHMe₂), 29.50, 20.95 (aryl-Me). Elemental Anal. Calcd for C₃₉H₅₅NO₄Ti: C, 72.09; H, 8.53; N, 2.16. Found C, 71.96; H, 8.66; N, 2.37.

Verification of 7

X-ray Crystalloeraphy for 7

Crystallographic measurements for 7 were performed at 173 K using a Bruker CCD-1000 diffractometer with Mo Kₐ (λ=0.71073 Å) radiation and a detector-to-crystal distance of 5.03 cm. Specimens of suitable quality and size (0.2×0.08×0.05 mm³) were selected and mounted onto glass fibers with silicon grease. The initial cell constants were obtained from three series of co scans at different starting angles. Each series consisted of 30 frames collected at intervals of 0.3° in a 10° range about o) with an exposure time of 50 seconds per frame. All the intensity data were corrected for Lorentz and polarization effects. The structures were solved by the direct method and were refined by a full-matrix anisotropic approximation. All hydrogen atoms were placed at idealized positions in the structure factor calculation and were allowed to ride on the neighboring atoms with relative isotropic displacement coefficients. Final least-squares refinement of 208 parameters against 2752 independent reflections converged to R (based on F² for I>2.0 σ) and wR (based on F for I>2.0 σ) of 0.0408 and 0.0986, respectively. Further details are listed in Table 1.

TABLE 1
Crystallographic Data for Compound 7

| | |
|---|---|
| empirical formula | C₂₄H₂₄F₁₀N₂O₈Ti₂ |
| formula weight | 377.13 |
| temp (K) | 173(2) |
| cryst syst | triclinic |
| space group | P1 |
| a (Å) | 7.0985(15) |
| b (Å) | 7.2229(15) |
| c (Å) | 13.930(3) |
| α (°) | 103.976(4) |
| β (°) | 93.096(4) |
| γ (°) | 101.600(4) |
| Volume (Å³) | 675.0(2) |
| Z | 1 |
| D_{calcd} (Mg/m³) | 1.856 |
| abs coeff (mm⁻¹) | 0.715 |
| F(000) | 380 |
| θ range (deg) | 2.97 to 28.25°. |
| reflections collected | 3461 |
| independent reflections | 2752 |
| no. of parameters refined | 208 |
| GOF | 0.975 |
| final R indices [I > 2 σ(I)]^{a} | R₁ = 0.0408, wR₂ = 0.0986 |
| R indices (all data) | R₁ = 0.0550, wR₂ = 0.1040 |
| largest diff. peak and hole (eÅ⁻³) | 0.425 and −0.409 |

^{a}R₁ = Σ∥F_{O}| − |F_{c}∥/Σ|Fₒ|and wR₂ = { Σ [w(Fₒ² − F_{c}²)²]/Σ [w(Fₒ²)²]}^{1/2}

Crystal and Molecular Structure of 7

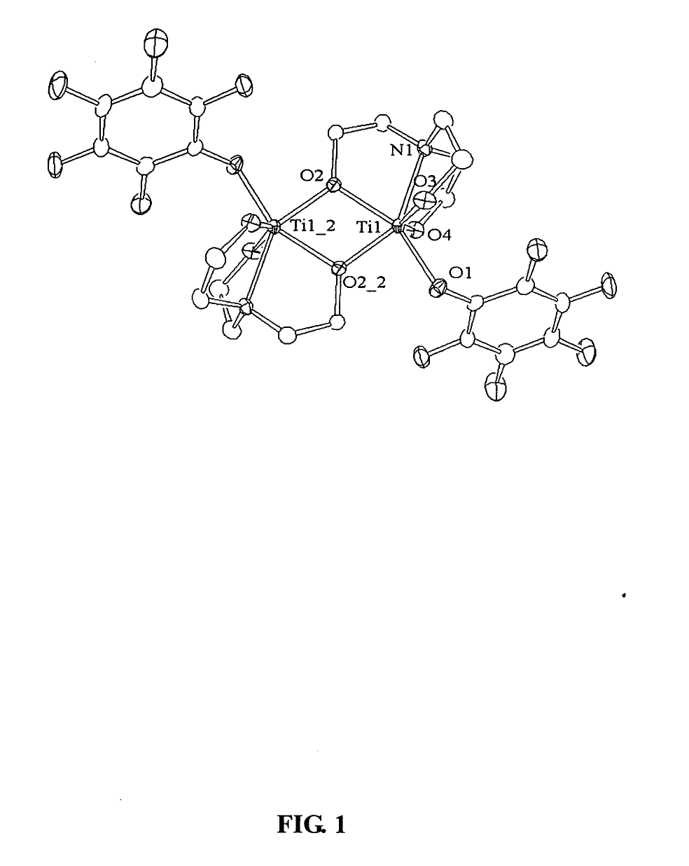

The ORTEP depiction of the structure is shown in FIG. 1. Selected bond distances include (Å): Ti1-O1=1.977(2), Ti1-O2=2.0588(19), Ti1-O3=1.8261(19), Ti1-O4=1.8320(19), Ti1-N1=2.284(2), Ti1-Ti1′=3.3107(11), Ti1-O2′=1.9881(18). Selected bond angles (°): O1-Ti1-N1=128.95(8), O1-Ti1-O2=155.37(7), O1-Ti1-O3=90.46(9), O1-Ti1-O4=85.42(8), O2-Ti1-O3=100.87(9), O1Ti1-O4=138.29(9) Selected interatomic distances and angles are also shown in Table 2.

TABLE 2
A comparison of bond angles (°) and
bond distances (Å) in dimeric titanatranes

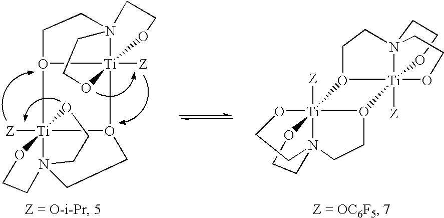

| structural parameter | 5* | 7 |
|---|---|---|
| O_{bridge} —Ti—Z(°) | 113.20(5) | 155.37(7) |
| N_{bridgehead} —Ti—O_{bridge}(°) | 75.23(4) | 145.40(8) |
| Ti—O_{bridge}—Ti′(°) | 109.66(5) | 109.77(8) |
| Ti—Ti(Å) | 3.356(1) | 3.3107(11) |
| Ti—N_{bridgehead}(Å) | 2.333(1) | 2.284(2) |
| Ti—O_{bridge}(Å) | 2.053(1) | 2.0235(19) |
| Ti—Oₜₑᵣₘᵢₙₐₗ(Å)^{a} | 1.854(1) | 1.8784(19) |

^{a}average value
*Harlow, R.L. Acta Crystallogr. 1983, C39, 1344, hereby incorporated by reference in its entirety.

The X-ray analysis of 7 revelas that its molecular structure features and “oxo” bridge as is commonly observed for titanatranes in the solid-state. As the ORTEP drawing in FIG. 1 illustrates, the geometry around each titanium in 7 can be viewed as a distorted octahedron. The four oxygen atoms of the ethylene arms form the equatorial plane and the axial sites are occupied by a nitrogen atom of the tripodal ligand and an oxygen atom of the pentafluorophenoxy group.

Although the only difference between 5 and 7 is the Z substituent of the alkoxide, the coordination geometry of 7 differs substantially from the one in compound 5 in that the axial Z substituent in 5 is trans to a nitrogen, whereas 7 is derived from 5 by a twist indicated by the curved arrows in the transformation shown in Table 2. It is possible that a more electron-donating substituent Z such as S-i-Pr or NMe₂ in a titanatrane would prefer to occupy a position trans to a bridging oxygen rather than to the more electron-donating tertiary bridgehead nitrogen atom such that an oxo-bridged dimeric titanatrane bearing a strongly electron-withdrawing substituent Z may be usefuil as a catalyst herein. Whether or not this is the case, it appears that influences such as subtle steric and/or crystal packing effects may play a role in determining solid state conformations of these compounds.

NMR Spectra

The chemical shift of the i-Pr group in the ¹H NMR spectra of 14 moves downfield in the same order as expected on the basis of the electron-withdrawing effect of the chlorides. Titanatranes 5-10 can be divided into four categories on the basis of their ¹H and ¹³C{¹H} NMR spectra. In the first category is 5, whose solution ¹H and ¹³C{¹H} NMR spectra are quite temperature-independent, displaying sharp resonances for two types of CH₂CH₂O protons. The spectra are consistent with monomeric behavior in solution, though it is a dimer in the solid state. Compounds 68 constitute a second category, for which the ¹H and ¹³C{¹H} NMR spectra are broadened at room temperature, presumably owing to an exchange process that is relatively slow on the NMR time scale. Since dilution of solutions of these dimers does not affect the breadth of their ¹H NMR spectra, the exchange process can be envisioned as being dominated by an intramnolecular “gearing” type of fluxionality around their Z—Ti—N axes rather than by dissociation into monomers. This gearing motion requires the breakage of only one bridge bond at a time with the subsequent formation of a new one as opposite rotations about the Z-Ti-N axes occur. Thus, ¹H NMR spectroscopic data for 7 in CDCl₃ are consistent with retention of the dimeric unit in solution. Room temperature ¹H and ¹³C{¹H} NMR spectra of 9 display sharp resonances which are consistent with the presence of two types of CH₂CH₂O groups in a 1:1 ratio. Because of the bulky nature of the apical substituent Z, this compound is monomeric in solution as well as in the solid state, thus representing a third category of titanatranes. The dimeric compound 10 is a member of a trivial fourth category for which the ¹H and ¹³C{¹H} NMR spectra are sharp over a wide temperature range.

The structures of 11-13 can be described as a “3-bladed turbine of C₃ symmetry,” a phrase known in the art. Although the presence of a transannular bond in 11 has not been verified, it is likely to exist based on its known presence in a titanatrane and in several silatranes containing the THA ligand. The ¹H NMR spectra of 11-13 display well-defined resonances possessing expected integrations. Compounds 12 and 13 should havepseudo-C₃ symmetry on the NMR time scale and therefore the benzylic CH₂ protons should not be equivalent. Indeed, the proximity of these protons to the aromatic rings may be responsible for the ca. 1.1 ppm chemical shift difference displayed in the room temperature spectra. Upon heating, compounds 12 and 13 assume pseudo-C₃ᵥ symmetry on the NMR time scale, and all six CH₂ protons become equivalent.

Polymerization Procedure

Overview

LA bulk polymerizations were carried out by charging a stirring bar, 2.00 g of LA and then the appropriate amount of catalyst precursor to a 10 mL Schlenk flask. The flask was then immersed in an oil bath at 130° C. and after the appropriate time, the reaction was terminated by the addition of 5 mL of methanol. The precipitated polymers were dissolved in a minimum amount of methylene chloride and then excess methanol was added. The resulting reprecipitated polymers were collected, washed with 3×50 mL of methanol and dried in vacuo at 50° C. for 12hr.

Solution polymerizations of LA were carried out by charging a stirring bar and LA to a 50 mL Schlenk flask in the glove box and then the appropriate amount of toluene was added to the flask at the desired polymerization temperature. Polymerization began with the addition of a stock toluene solution of the titanium compound. After the appropriate time, the reaction was terminated by the addition of 5 mL of methanol. The polymers precipitated polymers were dissolved in a minimum amount of methylene chloride and then excess methanol was added. The reprecipitated polymers were collected, washed with 3×50 mL of methanol and dried in vacuo at 50° C. for 12 hr. ¹H and ¹³C{¹H} NMR spectra of PLA samples were recorded in CDCl₃.

A polymerization resumption experiment was carried out after the desired polymerization time had been reached. The toluene reaction mixture was transferred via cannula to a 50 mL Schlenk flask containing a stirring bar and then another portion of LA that had been heated to the desired polymerization temperature was added. The remaining workup steps were the same as those described above. ¹H and ¹³C{¹H} NMR spectra of PLA samples were recorded in CDCl₃.

Bulk Polymerization of LA

Bulk ROP of LA initiated by 1-14 was carried out at 130° C. with the [LA]/[Ti] ratio fixed at 300, and Table 3 shows that all of these compounds were effective catalysts.

TABLE 3
Bulk polymerization of LA at 130° C.

| Entry | catalyst^{a} | lactide | time | yield | M_{w}^{b} | Mₙ^{b} | PDI^{b} |
|---|---|---|---|---|---|---|---|
| 1 | 1 | l-LA | 2 hr | 75 | 35,700 | 16,000 | 2.24 |
| 2 | | rac-LA | 2 hr | 71 | 41,100 | 19,600 | 2.10 |
| 3 | 2 | l-LA | 2 hr | 79 | 40,700 | 27,600 | 1.47 |
| 4 | | rac-LA | 2 hr | 75 | 38,000 | 23,800 | 1.60 |
| 5 | 3 | l-LA | 2 hr | 92 | 36,900 | 19,900 | 1.85 |
| 6 | | rac-LA | 2 hr | 90 | 34,900 | 28,400 | 1.23 |
| 7 | 4 | l-LA | 2 hr | 94 | 79,500 | 60,900 | 1.31 |
| 8 | | rac-LA | 2 hr | 93 | 97,600 | 68,600 | 1.42 |
| 9 | 1 | l-LA | 30 min | 20 | —^{c} | —^{c} | —^{c} |
| 10 | 2 | l-LA | 30 min | 29 | —^{c} | —^{c} | —^{c} |
| 11 | 3 | l-LA | 30 min | 37 | —^{c} | —^{c} | —^{c} |
| 12 | 4 | l-LA | 30 min | 46 | —^{c} | —^{c} | —^{c} |
| 13 | 5 | l-LA | 2 hr | 69 | 135,400 | 80,000 | 1.69 |
| 14 | | rac-LA | 2 hr | 66 | 132,600 | 78,200 | 1.70 |
| 15 | | l-LA | 15 hr | 92 | 270,300 | 73,500 | 3.68 |
| 16 | | rac-LA | 15 hr | 90 | 303,600 | 119,200 | 2.55 |
| 17 | 6 | l-LA | 4 hr | 71 | 73,500 | 39,500 | 1.86 |
| 18 | | rac-LA | 4 hr | 75 | 38,900 | 21,800 | 1.78 |
| 19 | | l-LA | 15 hr | 91 | 188,200 | 101,100 | 1.86 |
| 20 | | rac-LA | 15 hr | 88 | 136,500 | 76,900 | 1.78 |
| 21 | 7 | l-LA | 4 hr | 92 | 91,100 | 63,200 | 1.44 |
| 22 | | rac-LA | 4 hr | 88 | 61,000 | 39,500 | 1.56 |
| 23 | | l-LA | 15 hr | 98 | 273,700 | 94,500 | 2.90 |
| 24 | | rac-LA | 15 hr | 93 | 245,000 | 93,200 | 2.63 |
| 25 | 8 | l-LA | 4 hr | 89 | 112,700 | 66,500 | 1.69 |
| 26 | | rac-LA | 4 hr | 84 | 44,000 | 25,500 | 1.72 |
| 27 | | l-LA | 15 hr | 96 | 223,100 | 110,900 | 2.01 |
| 28 | | rac-LA | 15 hr | 95 | 142,500 | 82,700 | 1.72 |
| 29 | 9 | l-LA | 4 hr | 84 | 65,800 | 43,900 | 1.50 |
| 30 | | rac-LA | 4 hr | 82 | 30,900 | 19,600 | 1.57 |
| 31 | | l-LA | 15 hr | 94 | 131,400 | 82,600 | 1.59 |
| 32 | | rac-LA | 15 hr | 91 | 115,500 | 67,900 | 1.70 |
| 33 | 10 | l-LA | 15 hr | 95 | 98,200 | 46,700 | 2.10 |
| 34 | | rac-LA | 15 hr | 91 | 72,800 | 34,700 | 2.10 |
| 35 | 11 | l-LA | 4 hr | 95 | 161,800 | 80,800 | 2.00 |
| 36 | | rac-LA | 4 hr | 94 | 194,400 | 96,000 | 2.02 |
| 37 | 12 | l-LA | 4 hr | 55 | 76,100 | 52,000 | 1.46 |
| 38 | | rac-LA | 4 hr | 53 | 51,400 | 38,000 | 1.35 |
| 39 | 13 | l-LA | 14 hr | 26 | 38,400 | 28,400 | 1.35 |
| 40 | | rac-LA | 14 hr | 24 | 43,400 | 30,200 | 1.44 |
| 41 | 14 | l-LA | 2 hr | 97 | 38,300 | 29,200 | 1.31 |
| 42 | | rac-LA | 2 hr | 94 | 31,200 | 20,000 | 1.56 |
| 43 | TiCl₄ | l-LA | 2 hr | 0 | — | — | — |

^{a}Oil bath temperature: 130 (±3) ° C., [LA]/[Ti]: 300, 2 g of LA.
^{b}The weight average molecular weights (M_{w}), the number average molecular weights (Mₙ) and the polydispersity indices (PDI = M_{w}/Mₙ) were determined by GPC.
^{c}not determined.

The end groups of PLA produced by 1-14 are the corresponding alkoxy ester units as indicated by ¹H NMR spectroscopy. TiCl₄ was also evaluated (Table 3, entry 43). Thus, initiation occurs through the insertion of the alkoxy group from the titanium catalyst into l-LA or rac-LA, consistent with a polymerization process that proceeds via a coordination-insertion mechanism. This was further supported by homonuclear decoupled ¹H NMR spectroscopy. Such spectra of PLA derived from rac-LA display the characteristic five methine resonances, whereas spectra of PLA derived from l-LA, exhibit only one methine peak. However, it is believed that some transesterification occurred during polymerization, since the PDI values of the resulting polymers were somewhat higher than expected for a controlled polymerization.

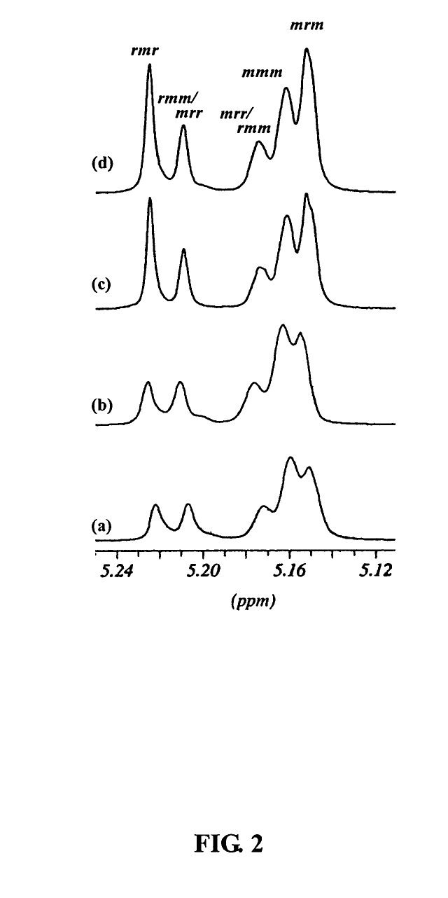

Proceeding from 1 to 4, catalytic activity and molecular weights generally increased, though the corresponding PDI values generally decreased in that order (Table 3, entries 1-8). It was not possible to distinguish between the relative catalytic activities of 3 and 4 and also between those of 1 and 2 on the basis of yield at the end of 2 h. Therefore the polymerizations were terminated at the end of 30 min when the trend in the yields for 1 to 4 was more apparent (Table 3, entries 9-12). With these catalysts it was also observed that the homonuclear decoupled ¹H NMR spectra of poly(rac-LA) derived from 3 and 4, respectively, in FIG. 2(c) and (d) are quite different from the spectra in FIG. 2(a) and 2(b) which were derived from 1 and 2, respectively. This result is consistent with that predicted from a Bemouillian analysis of totally random poly(rac-LA). The methine region in the homonuclear decoupled ¹H NMR spectrum of poly(rac-LA) derived from 3 and 4 displays rmr and mrm tetrads which are much more intense than expected. These observations are consistent with a heterotactic-biased poly(rac-LA) since the rmr microstructure can only arise from two consecutive D-L or L-D interchanges. Each rmr tetrad is accompanied by two mrm tetrads in agreement with the NMR integration (Table 3, entries 6 and 8). The preference for heterotacticity in the poly(rac-LA) is less than average, but tacticity bias is about average. It is interesting that in proceeding from 1 to 4 (Table 3, entries 2, 4, 6 and 8), the intensity of heterotactic-biased poly(rac-LA) augments significantly for reasons that are not obvious, especially since the precise mechanism for preferred heterotacticity is currently unknown.

It is worth noting that titanatranes 5-9 provide PLA with significantly increased molecular weights which are associated with the polymerization time (Table 3, entries 13-32). The same result was also observed in the syndiospecific polymerization of styrene using Cp*Ti(OCH₂CH₂)₃N, in which there is also a transannular bond from the bridgehead nitrogen to the titanium. The unexpectedly high molecular weights may be due to a faster rate of propagation than initiation. This notion was supported by the observation of bimodal GPC traces for some of the polymer samples. Thus although such traces of the polymers prepared using 5-9 with [LA]/[Ti] =300 were unimodal up to 80% conversion, they began to show bimodal peaks at conversions greater than 90%, which is consistent with the predictable effects of transesterification processes in lactone polymerization. Thus, when transesterification effectively competes with ROP, the PDI values of the resultant polymers should rise with increasing conversion, and molecular weight distributions may be bimodal.

The same bimodal GPC patterns were observed in PLA prepared with 10 (which is a dialkoxide-bridged bis-titanatrane) and by 11 (Table 3, entry 33-36).

Compound 10 contains a pinacolate ligand, which could allow this catalyst to behave as a difunctional initiator in the polymerization of LA, thus leading to a significant increase in molecular weight than with other titanatranes. However, no significant increase of molecular weight was observed with the use of 10. Moreover, elemental analysis revealed that there is less than 0.003% titanium in the polymer obtained with this catalyst, which is far less than the 0.049% expected had not the titanatrane structure at both ends of the anticipated polymer chain been solvolyzed by the excess MeOH used to isolate and purify the polymers.

In terms of yield and molecular weight, titanatrane 11 is the most effective PLA bulk polymerization catalyst among the fourteen catalysts studied. According to an elemental analysis of the product polymer obtained with this five-membered ring catalyst, the residual titanium content is less than 0.001%. The question then arises as to whether six-membered ring titanatranes with fused ortho-phenyls in the bridges may be more active catalysts for making PLA than five-membered ring 11, for example. Titanatranes such as 12 and 13 might be expected to exhibit weak/long bridgehead-bridgehead Ti—N interactions. Despite the absence of X-ray structural data for 12 and 13, two similar compounds [(2,6-di-i-Pr-PhO)Ti(O-2,4-Me₂C₆H₂CH₂)₃N and i-PrOTi(O-2,4-tert-BU₂C₆H₂CH₂)₃N] are known to have Ti—N distances of 2.306(2) and 2.334(5) Å, respectively, which signifies the presence of transannular bonds that fall at the long end of the range between 2.264(3) and 2.342(9) Å observed in other structurally characterized titanium trialkanolamine derivatives. See Kim, et al., Organometallics 2002, 21, 2395 and Kol, et al., Inorg. Chem. Commun. 2001, 4, 177, both incorporated herein in their entirety.

The data in entries 37-40 in Table 3 reveal that 12 and 13 are considerably poorer catalysts than 5 or 11. It is believed this is primarily due to the greater steric protection of the titanium in 12 or 13, particularly in the region above the equatorial plane in these molecules, where the methyl or tert-butyl substituent on the six-membered rings can accentuate blockage of titanium ligation in the coordination-insertion step. In accord with this idea is the observation that less sterically hindered 12 shows higher activity and affords a greater polymer molecular weight than 13. Although the PDI values associated with the PLA polymers produced by 12 and 13 were smaller than those for the products provided by 5 and 11, the polymer molecular weights are also considerably lower for 12 and 13, although such polymers are still potentially quite useful in certain applications.

In the presence of methylaluminoxane, CpTi(OR)₃ compounds are well-known to catalyze the syndiospecific polymerization of styrene. Compound 14 also contains alkoxide groups that could function as initiators of LA polymerization, and entries 41 and 42 in Table 2 show that it too is a good catalyst, giving PLA in high yields and with moderate PDI and molecular weight values.

Solution Polymerization of LA and CL

Table 4 shows the results of experiments carried out in toluene solution with different [LA]/[Ti] ratios, with various polymerization times, and at temperatures higher than 50° C. (owing to a lack of sufficient solubility of the monomer and polymers at lower temperatures).

TABLE 4
Solution Polymerization of LA

| | | monomer | [M]/ | T^{d} | | Yield^{e} | | | |
|---|---|---|---|---|---|---|---|---|---|
| entry | catalyst | type | [Ti] | (° C.) | time | (%) | M_{w}^{g} | Mₙ^{g} | PDI^{g} |
| 1 | 1 | l-LA^{a} | 300 | 70 | 24 hr | 85 | 28,700 | 14,300 | 2.01 |
| 2 | | rac-LA^{a} | 300 | 70 | 24 hr | 70 | 16,900 | 9,200 | 1.83 |
| 3 | 2 | l-LA^{b} | 200 | 70 | 4 hr | 15 (20)^{f} | 4,600 | 4,200 | 1.10 |
| 4 | | l-LA^{b} | 200 | 70 | 16 hr | 55 (58)^{f} | 13,600 | 12,800 | 1.06 |
| 5 | | l-LA^{b} | 200 | 70 | 20 hr | 65 (69)^{f} | 16,300 | 15,100 | 1.08 |
| 6 | | l-LA^{b} | 200 | 70 | 24 hr | 81 (85)^{f} | 20,200 | 18,400 | 1.10 |
| 7 | | l-LA^{b} | 300^{h} | 70 | 36 hr^{h} | 78 | 30,700 | 27,300 | 1.12 |
| 8 | | ε- | 125 | 70 | 24 hr | 52 | 12,000 | 10,600 | 1.13 |
| 9 | | ε- | 175 | 70 | 24 hr | 77 | 16,700 | 15,800 | 1.06 |
| 10 | | rac-LA^{b} | 200 | 70 | 24 hr | 87 | 17,600 | 16,300 | 1.07 |
| 11 | 3 | l-LA^{a} | 200 | 70 | 6 hr | 26 | 6,200 | 5,600 | 1.10 |
| 12 | | rac-LA^{a} | 200 | 70 | 6 hr | 28 | 5,600 | 5,200 | 1.08 |
| 13 | 4 | l-LA^{a} | 300 | 130 | 24 hr | 53 | 61,500 | 51,100 | 1.20 |
| 14 | | rac-LA^{a} | 300 | 130 | 24 hr | 48 | 44,500 | 37,000 | 1.20 |
| 15 | 5 | l-LA^{b} | 300 | 70 | 3 hr | 7 (8)^{f} | 3,000 | 2,800 | 1.09 |
| 16 | | l-LA^{b} | 300 | 70 | 10 hr | 21 (25)^{f} | 11,500 | 10,000 | 1.15 |
| 17 | | l-LA^{b} | 300 | 70 | 14 hr | 29 (31)^{f} | 13,500 | 12,500 | 1.08 |
| 18 | | l-LA^{b} | 300 | 70 | 17 hr | 28 (35)^{f} | 14,200 | 13,300 | 1.07 |
| 19 | | l-LA^{b} | 300 | 70 | 36 hr | 58 (70)^{f} | 28,900 | 28,000 | 1.03 |
| 20 | | l-LA^{b} | 300 | 130 | 24 hr | 81 | 34,300 | 25,400 | 1.35 |
| 21 | | rac-LA^{b} | 300 | 50 | 15 hr | 16 | 14,400 | 13,200 | 1.09 |
| 22 | | ε- | 200 | 70 | 24 hr | 89 | 19,400 | 17,600 | 1.10 |
| 23 | 6 | l-LA^{b} | 200 | 130 | 24 hr | 43 | 12,300 | 9,400 | 1.31 |
| 24 | 7 | l-LA^{b} | 300 | 130 | 24 hr | 58 | 25,800 | 18,600 | 1.39 |
| 25 | 8 | l-LA^{b} | 400 | 130 | 24 hr | 51 | 43,200 | 35,200 | 1.23 |
| 26 | 9 | l-LA^{b} | 200 | 130 | 24 hr | 17 | 13,600 | 10,500 | 1.29 |
| 27 | 10 | l-LA^{a} | 300 | 130 | 24 hr | 26 | 25,800 | 17,400 | 1.49 |
| 28 | | rac-LA^{a} | 300 | 130 | 24 hr | 24 | 23,000 | 15,800 | 1.45 |
| 29 | 11 | l-LA^{a} | 300 | 130 | 24 hr | 68 | 18,500 | 11,100 | 1.66 |
| 30 | | rac-LA^{a} | 300 | 130 | 24 hr | 64 | 17,500 | 13,100 | 1.34 |
| 31 | 12 | l-LA^{a} | 300 | 130 | 24 hr | 0 | — | — | — |
| 32 | 13 | l-LA^{a} | 300 | 130 | 24 hr | 0 | — | — | — |
| 33 | 14 | l-LA^{a} | 300 | 130 | 12 hr | 63 | 8,000 | 6,700 | 1.20 |
| 34 | | rac-LA^{a} | 300 | 130 | 12 hr | 59 | 9,000 | 8,300 | 1.09 |

^{a}Solvent: 40 mL of toluene, 2 g of LA.
^{b}Solvent: 30 mL of toluene, 2 g of LA.
^{c}Solvent: 30 mL of toluene, 2 g of ε-caprolactone.
^{d}Oil bath temperature: 130 (±3) ° C.
^{e}Isolated Yield
^{f}Conversion determined via integration of the methine resonances of LA and PLA (CDCl₃).
^{g}See Table 2, footnote b.
^{h}Continuation of polymerization after equilibrium was established

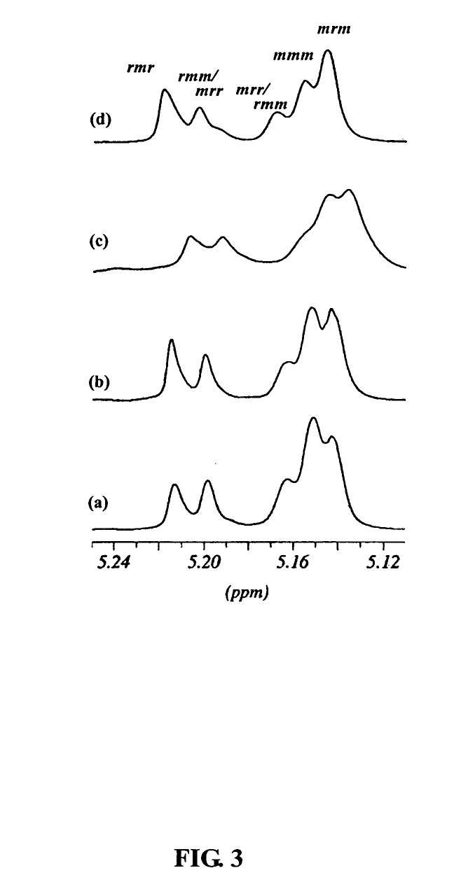

The yields and molecular weights of the polymers obtained using 1-14 in toluene were inferior compared with those synthesized in the bulk polymerization experiments. The PDI values of the polymers obtained using catalysts other than 1 and 10-13 in Table 3 are quite small, indicating a substantial degree of molecular weight control. Even though the polymerizations were carried out in toluene, 1 gave rise to PLA with a high PDI value, which may be associated with the dissociation of more than one O-i-Pr group from 1, thus generating more than one initiating site (Table 4, entries 1-2). On the other hand, 2 and 3, which contain more than one chlorine atom, generated PLA with very narrow PDI values (entries 3-12, Table 4). This suggests that the presence of chlorine atoms in chlorotitanium alkoxides may permit only one O-i-Pr group to dissociate. In keeping with this suggestion, the methine region in the homonuclear decoupled ¹H NMR spectrum of poly(rac-LA) derived from 4 displayed rmr and mrm tetrads that were much more intense than expected [as was also observed under bulk polymerization conditions for this catalyst (FIG. 3(d))]. In progressing from 1 to 4 (Table 4, entries 2, 10, 12 and 14), the intensity in the ¹H NMR spectra of heterotactic-biased poly(rac-LA) increased, although, to a lesser degree than in such spectra of the bulk polymerization product (FIG. 3).

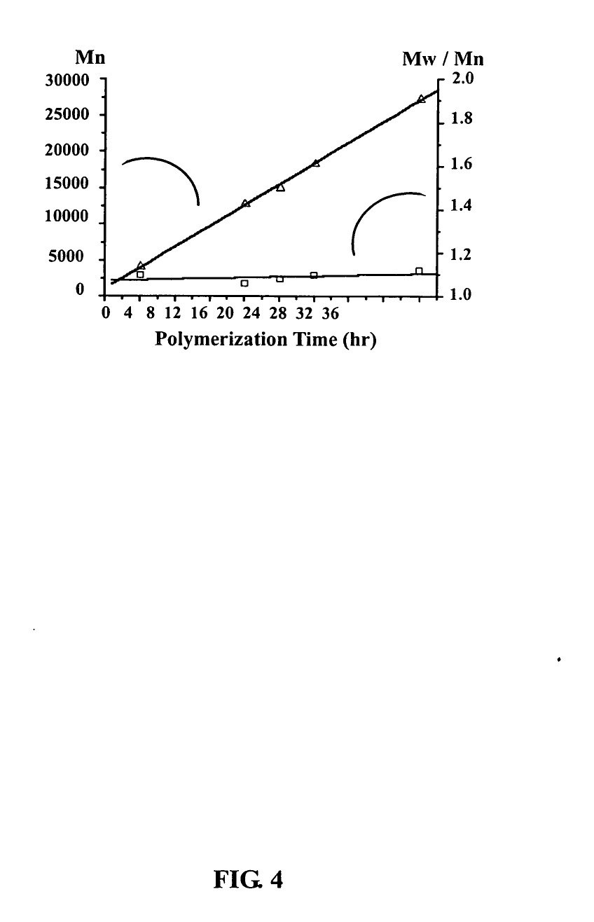

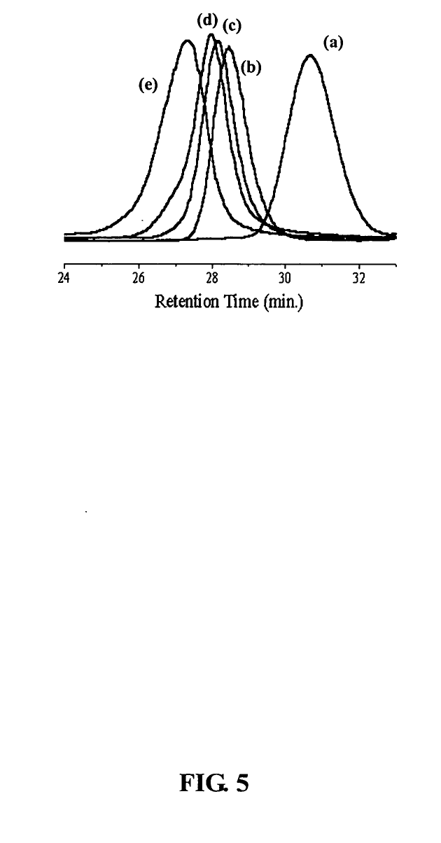

For a further investigation of the degree of control in these polymerizations, catalysts 2 and 5 were selected. The PDI values of PLA obtained with 2 ranged from 1.06 to 1.12. These values vary linearly with Mₙ and with the conversion as shown in FIG. 4 (Table 4, entries 3-6), implying a very substantially controlled polymerization process. The controlled nature of these polymerizations was further confirmed by a polymerization resumption experiment that resulted in further ROP of LA. In this experiment (Table 4, entry 7), an additional 100 equivalents of LA monomer was added to the reaction medium corresponding to that of entry 6 in Table 3. The GPC traces in FIG. 5 show that the molecular weight increased for the final polymer (peak e, Mₙ=27,300, PDI=1.12) relative to the initial product (peak d, Mₙ=18,400, PDI=1.10).

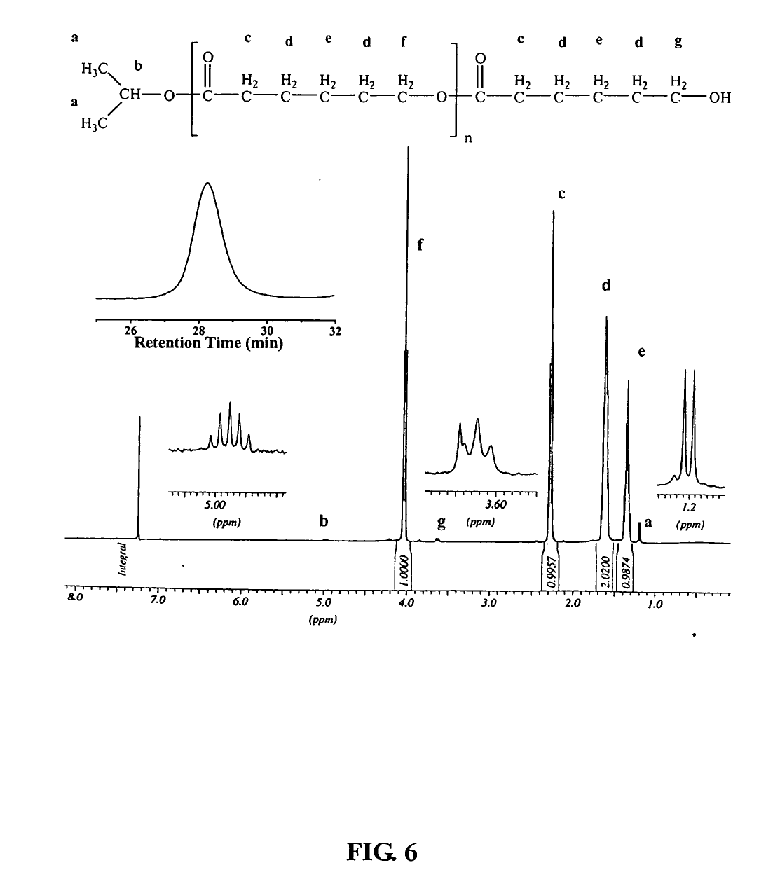

In an effort to better understand the initiating process, ¹H NMR studies on PCL [poly(ε-caprolactone)] formation initiated by 2 were carried out as shown in FIG. 6. The ¹H NMR spectrum of PCL indicates that initiation occurs through the insertion of an O-i-Pr group from compound 2 to CL, giving a titanium alkoxide intermediate that further reacts with excess CL giving PCL (Table 4, entries 8 and 9). This result is in agreement with the expectation that the polymer chain should terminate with one i-Pr ester and one hydroxy end group, the latter arising from methanolysis of the metal alkoxide terminus present during polymerization.

This experiment was also carried out for PLA obtained with catalyst 2 with the analogous result, suggesting that back-biting reactions do not occur to any appreciable extent under these conditions. This conclusion was further verified by the following observations. First, the homonuclear decoupled ¹H NMR spectrum reveals only one resonance and five resonances in the methine region for poly(l-LA) and poly(rac-LA), respectively. Thus if back-biting reactions had occurred, side peaks would have been observed. Second, if intermolecular cyclization reactions had taken place during polymerization, the PDI values of the resulting PLA would have been substantially higher than the nearly ideal values observed. Interestingly, epimerization of the chiral centers in poly(l-LA) apparently does not occur to a detectable extent according to the homonuclear decoupled ¹H NMR spectra for the methine region.

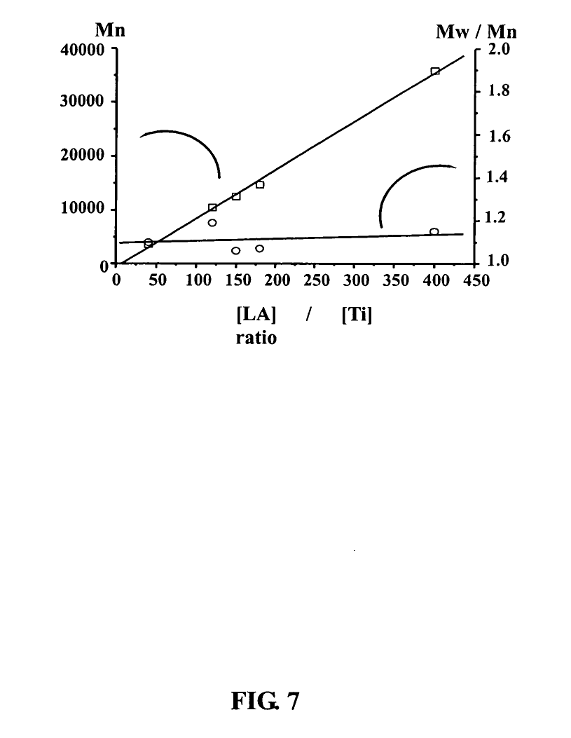

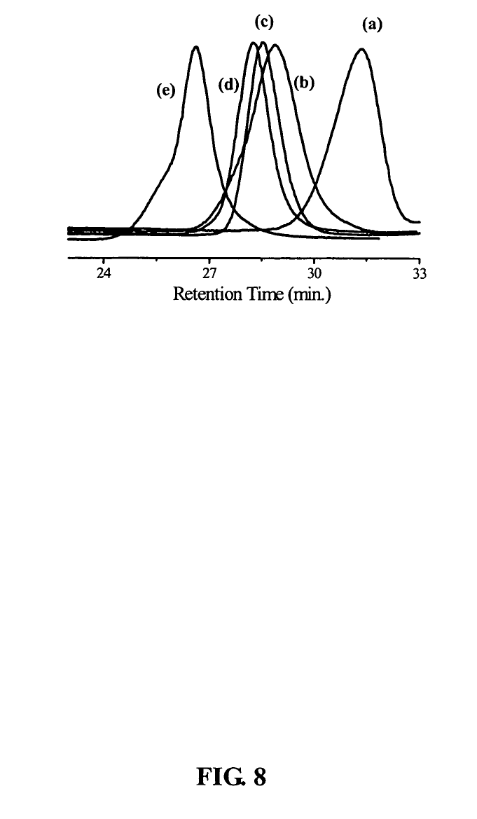

In the case of 5, PLA polymers with narrow PDI values were obtained from reactions conducted with a fixed [LA]/[Ti] ratio of 300 at 70° C. The linear relationship between Mn and the conversion shown in FIG. 7 (Table 4, entries 15-19), implies that polymerization was substantially controlled. To aid in understanding the initiating process in PCL formation initiated by 5, ¹H NMR studies were carried out (FIG. 8, Table 4, entry 22). These spectra indicate that initiation occurs through the insertion of an O-i-Pr group from 5 into the CL molecule, giving a titanium alkoxide intermediate. This observation accords with expectations that the polymer chain should possess an i-Pr ester and a hydroxy end group.

At the higher polymerization temperature of 130° C. and at the higher [LA]/[Ti] ratio of 300, the PDI value for PLA using initiator 5 increases (Mₙ=25,400, PDI=1.35, Table 4 entry 20) but a significant increase in polymer yield did not occur. This tendency toward increased PDI values at this temperature was also observed for titanatranes 6-11 (Table 4, entry 23-30) along with dramatically decreased polymer yields. At the higher polymerization temperatures, titanatranes increasingly initiate transesterification reactions, which could account for the augmented PDI values. Interestingly, 12 and 13 did not show any catalytic activities for the solution polymerization of LA though they showed moderate catalytic activity in bulk polymerizations. In addition, 14 gave PLA of very low molecular weight when compared with other titanium compounds, although the PDI values are quite narrow.

Summary and Conclusions

A series of titanium alkoxides were synthesized from readily available starting materials by simple procedures in high yields. These compounds showed remarkably high catalytic activity in bulk and solution polymerizations of LA, revealing interesting correlations of catalyst structure with polymer activity. The catalysts can be roughly divided into two categories: simple tetra-coordinate titanium complexes (1-4 and 14) and penta-coordinate complexes (5-13) derived from tetradentate trisalkoxy- or trisaryloxyamine ligands. Additionally, pentacoordinate 5-13 break down into a set of three five-membered ring titanatranes (5-11) and three six-membered ring analogs (12 and 13). Although the different ring sizes result in only minor structural changes in these compounds, they give rise to a major effect on their polymerization activity and the characteristics of the resulting polymers, with five-member ring systems affording polymers in higher yields and with larger molecular weights than their six-membered ring counterparts.

Increased heterotactic-biased poly(rac-LA) was formed as the number of chlorine atoms increased in TiClₓ(O-i-Pr)₄₋ₓ. In solution polymerizations, titanium alkoxides catalyzed controlled polymerizations of LA, and end group analysis demonstrated that an alkoxide group acted as the initiator. That polymerization is controlled under these conditions was shown by the linearity of molecular weight versus the conversion of LA into PLA.

### EXAMPLE 2

General Considerations

All reactions were carried out under an argon atmosphere using standard Schlenk and glove box techniques. See Shriver, supra. All chemicals were purchased from Aldrich and were used as supplied unless otherwise indicated. THF and toluene (Fischer HPLC grade) were dried and purified under a nitrogen atmosphere in a Grubbs-type nonhazardous two-column solvent purification system (Innovative Technologies) and were stored over activated 3 Å molecular sieves. See Pangborn, et al., supra. All deuterium solvents were dried over activated molecular sieves (3 Å) and were used after vacuum transfer to a Schlenk tube equipped with J. Young valve.

¹H and ¹³C{¹H}-NMR spectra were recorded at ambient temperature on a Varian VXR-400, VXR-300 or Bruker AC200 NMR spectrometer using standard parameters. The chemical shifts are referenced to the residual peaks of CDCl₃(7.24 ppm, ¹H NMR; 77.0 ppm, ¹³C{¹H} NMR) and C₆D₆ (7.15 ppm, ¹H NMR; 128 ppm, in ¹³C{¹H} NMR). Elemental analyses were performed by Desert Analytics Laboratory. Molecular weights of polymers were determined by gel permeation chromatography (GPC) and the measurements were carried out at room temperature with THF as the eluent (1 mL/min) using a Waters 510 pump, a Waters 717 Plus Autosampler, four Polymer Laboratories PLgel columns (100, 500, 10⁴, 10⁵ Å) in series, and a Wyatt Optilab DSP interferometric refractometer as a detector. The columns were calibrated with polystyrene standards.

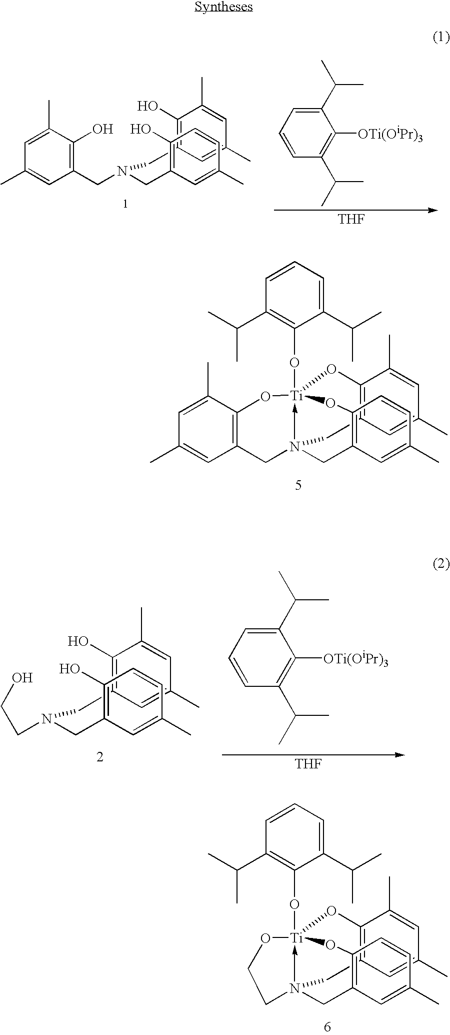

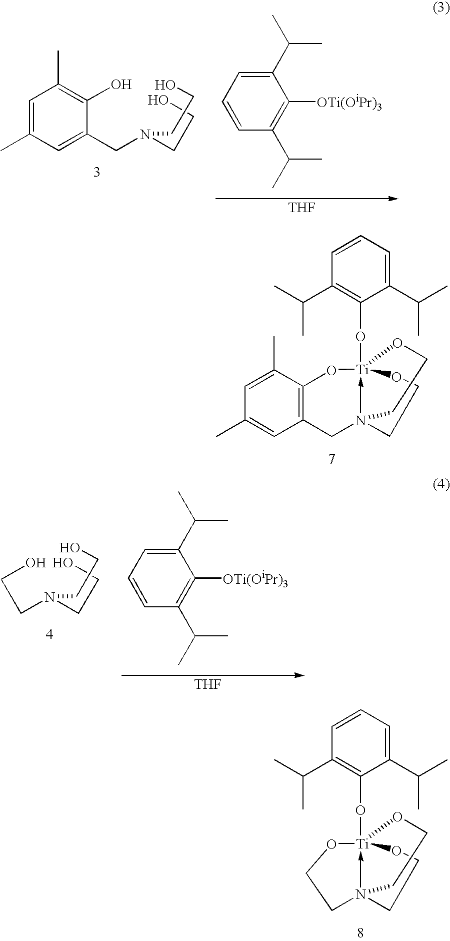

Compounds 6-8 were made by a procedure analogous to that given here for 5. To a THF solution composed of 2,6-di-i-Pr-phenol (0.891 g, 5.00 mmol) in 10 mL of THF was added dropwise at room temperature a solution of Ti(O-i-Pr)₄ (1.42 g, 5.00 mmol) in 10 mL of THF. After 1 hr, a solution of nitrilo-tris(2-hydroxy-3,5-dimethylbenzyl)amine (2.10 g, 5.00 mmol) in 10 mL of THF was added dropwise to the reaction vessel. The reaction mixture was stirred at room temperature overnight and then the volatiles were evaporated under vacuum, leaving an orange-yellow solid, to which was added 15 mL of toluene. The orange solution was filtered and the desired product 5 was isolated as orange-yellow crystals after the solution remained at −15° C. in a refrigerator for a few days (2.25 g, 70%).

X-ray Crystallography for 5 and 6

The crystallographic measurements were performed at 173K for 5 or 293K for 6 using a Bruker CCD-1000 diffractometer with Mo Kₐ (λ=0.71073 Å) radiation and a detector-to-crystal distance of 5.03 cm. Specimens of suitable quality and size (0.2×0.2×0.2 mm³) were selected and mounted onto glass fibers with silicon grease or epoxy glue. The initial cell constants were obtained from three series of co scans at different starting angles. Each series consisted of 30 frames collected at intervals of 0.3° in a 10° range about co with the exposure time of 30 seconds per frame for 5 and with an exposure time 20 sec per frame for 6. All the intensity data were corrected for Lorentz and polarization effects. The structures were solved by the Patterson method and the direct method and were refined by full-matrix anisotropic approximation. All hydrogen atoms were placed at idealized positions in the structure factor calculation and were allowed to ride on the neighboring atoms with relative isotropic displacement coefficients. Final refinement based on the reflections (I>2.0μ(l)) converged at R1=0.0586, wR2=0.1772, and GOF=1.089 for 5 and at R1=0.0562, wR2=0.1538, and GOF=1.017 for 6. Further details are listed in Table 5.

TABLE 5
Crystallographic Data and Parameters for 5 and 6

| | 5 | 6 |
|---|---|---|
| formula | C₄₁H₅₁NO_{4.5}Ti | C₃₄H₄₅NO_{4.5}Ti |
| Fw | 677.73 | 585.59 |
| Crystal system | Monoclinic | Triclinic |
| space group | P2/n | P-1 |
| a (Å) | 14.890(4) | 10.2280(19) |
| b (Å) | 11.530(3) | 11.448(2) |
| c (Å) | 22.378(6) | 15.344(3) |
| α (deg) | 90 | 70.710(3) |
| β (deg) | 105.533(4) | 85.085(4) |
| γ (deg) | 90 | 80.038(3) |
| V (Å³) | 3701.6(17) | 1669.4(5) |
| Z | 4 | 2 |
| d_{c} (g/cm³) | 1.216 | 1.165 |
| F (000) | 1448 | 624 |
| T (K) | 173(2) | 293(2) |
| Absorption coefficient (mm⁻¹) | 0.273 | 0.293 |
| θ range (deg) | 1.89; 26.38 | 1.91; 20.82 |
| Reflections collected | 29943 | 8305 |
| Independent reflections | 7539 | 3489 |
| no. of params refined | 429 | 388 |
| R₁^{a} | 0.0586 | 0.0562 |
| wR₂^{a} | 0.1772 | 0.1538 |
| GOF | 1.089 | 1.017 |
| min and max dens (e Å⁻³) | 1.156, −0.426 | 0.476, −0.264 |

^{a}R₁ = Σ∥F_{O}| − |F_{c}∥/Σ|Fₒ| and wR₂ = { Σ [w(Fₒ² − F_{c}²)²]/Σ [w(Fₒ²)²]}^{1/2}

NMR Spectra

¹H NMR (CDCl₃, 400.147 MHz): δ 7.18-6.73 (m, 9H, aryl-H), 4.11 (m, 5H, overlap of CHMe₂ with NCH₂-aryl), 2.97 (d, J=13.4 Hz, 3H, NCH₂-aryl), 2.23 (d, J=3.0 Hz, 9H, aryl-Me), 2.06 (d, J=4.0 Hz, 9H, aryl-Me), 1.24 (s, 12H, CHMe₂). ¹H NMR (C₆D₆, 400.147 MHz): δ 7.28 (d, J=7.6 Hz, 2H, aryl-H), 7.09 (m, 1H, aryl-H), 6.74 (s, 3H, aryl-H), 6.40 (s, 3H, aryl-H), 4.48 (m, 2H, CHMe₂), 3.95 (d, J=13.8 Hz, 3H, NCH₂-aryl), 2.45 (d, J=13.8 Hz, 3H, NCH₂-aryl), 2.20 (s, 9H, aryl-Me), 2.14 (s, 9H, aryl -Me), 1.45 (t, J=7.2 Hz, 12H, overlapping pair of doublets for CHMe₂). ¹³C{¹H} NMR (CDCl₃, 100.626 MHz): δ 162.5, 159.7, 137.6, 130.8, 129.9, 127.3, 124.1, 123.3, 122.5, 121.3 (aryl), 58.56 (NCH₂), 26.67 (CHMe₂), 23.93 (CHMe₂), 23.73 (CHMe₂), 20.59 (aryl-Me), 15.85 (aryl-Me). Elemental Anal. Calcd for C₃₉H₄₇NO₄T·⅓ toluene: C, 73.83; H, 7.44; N, 2.08. Found C, 74.10; H, 7.59; N, 2.16.

Yield, 62%; ¹H NMR (CDCl₃, 400.147 MHz): δ 7.27-6.80 (m, 7H, aryl-H), 4.53 (t, J=5.6 Hz, 2H, CH₂O), 4.00 (m, 2H, CHMe₂), 3.91 (d, J=13.4 Hz, 2H, NCH₂-aryl), 3.63 (d, J=13.4 Hz, 2H, NCH₂-aryl), 3.00 (br s, 2H, NCH₂CH₂), 2.25 (s, 6H, aryl-Me), 2.15 (s, 6H, aryl-Me), 1.29 (d, J=6.9 Hz, 12H, CHMe₂). ¹³C{¹H} NMR (CDCl₃, 100.626 MHz): δ 161.4, 159.1, 138.0, 131.1, 129.4, 127.6, 124.8, 122.9, 122.6, 121.0 (aryl), 72.00 (CH₂O), 57.18 (NCH₂-aryl), 56.85 (NCH₂CH₂), 26.76 (CHMe₂), 23.65 (CliMe₂), 20.55 (aryl-Me), 16.11 (aryl-Me). Elemental Anal. Calcd for C₃₂H₄₁NO₄Ti·⅓ toluene: C, 70.82; H, 7.56; N, 2.41. Found C, 70.96; H, 7.83; N, 2.53.

Yield, 67%; ¹H NMR (CDCl₃, 400.147 MHz): δ 7.07-6.81 (m, 5H, aryl-H), 4.60 (t, J=5.8 Hz, 2H, CH₂O), 4.45 (t, J=5.6 Hz, 2H, CH₂O), 3.96 (s, 2H, CH₂O), 3.80 (t, J=6.4 Hz, 2H, CHMe₂), 3.20 (t, J=5.6 Hz, 2H, NCH₂CH₂), 3.13(t, J=5.8 Hz, 2H, NCH₂CH₂), 2.25 (s, 3H, aryl-Me), 2.16 (s, 3H, aryl-Me), 1.27 (d, J=6.7 Hz, 12H, CHMe₂). ¹³C{¹H} NMR (CDCl₃, 100.626 MHz): δ 160.7, 158.9, 138.1, 133.5, 131.3, 128.9, 127.9, 125.4, 123.4, 122.6, 120.7, 120.5 (aryl), 71.56 (CH₂O), 56.34 (NCH₂-aryl), 26.80 (CHMe₂), 23.50 (CHMe₂), 22.75 (CHMe₂), 20.50 (aryl-Me), 16.67 (aryl-Me). Elemental Anal. Calcd for C₂₅H₃₅NO₄Ti: C, 65.08; H, 7.65; N, 3.04. Found C, 64.60; H, 7.94; N, 3.11.

Yield, 76%; ¹H NMR (CDCl₃, 400.147 MHz): δ 7.02 (d, J=7.6 Hz, 2H, aryl-H), 6.84 (t, J=7.6 Hz, 1H, aryl-H), 4.54 (t, J=5.6 Hz, 6H, CH₂O), 3.62 (m, 2H, CHMe₂), 3.29 (t, J=5.5 Hz, 6H, NCH₂), 1.25 (d, J=6.9 Hz, 12H, CHMe₂). ¹³C{¹H} NMR (CDCl₃, 100.626 MHz): 8 160.0, 137.9, 122.4, 120.4 (aryl), 71.17 (CR2O), 56.78 (NCH₂), 26.84 (CRMe₂), 23.33 (CHMe₂). Elemental Anal. Calcd for C₁₈H₂₉NO₄Ti: C, 58.23; H, 7.87; N, 3.77. Found C, 58.35; H, 8.12; N, 3.79.

Polymerization Procedure

LA polymerizations were carried out as follows: 2.00 g of LA and then the appropriate amount of catalyst precursor was charged to a 25 mL Schlenk flask. The flask was then immersed in an oil bath at 130° C. After 24 h, the reaction was terminated by the addition of 5 mL of methanol. The polymers so obtained as precipitates were dissolved in a minimum amount of methylene chloride and then excess methanol was added. The resulting reprecipitated polymers were collected, washed with 3×50 mL of methanol and dried in vacuo at 50° C. for 12 hr.

Results and Discussion

The treatment of Ti(O-i-Pr)₄ with one equiv of 2,6-di-i-Pr-phenol and one equiv of the ligand precursors 1-4 in THF gave, after workup, the novel titanatranes 5-8 as orange-yellow crystals in 62-76% isolated yield. These four products in the solid state were stable in air for a few weeks and, according to ¹H NMR spectroscopy, they decomposed slightly after a few days at room temperature in CDCl₃ solutions contained in capped NMR tubes. They are soluble in polar organic solvents and in toluene, but are insoluble in alkanes such as n-hexane.

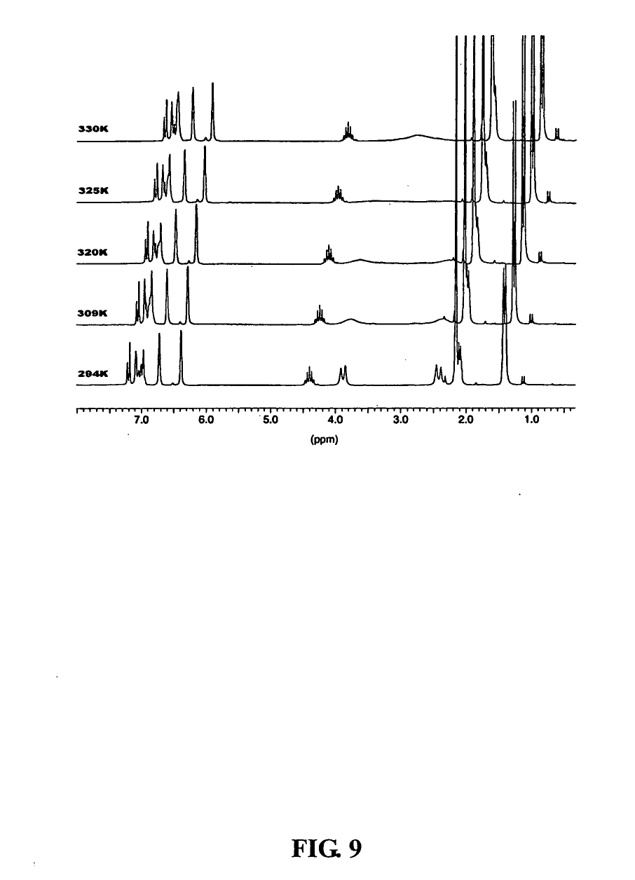

The ¹H NMR spectra of 5-8 display well-defined resonances with their expected integrations. At 325K in toluene-d₈ solution, the two resonances for aryl methylene protons in 5 coalesce to a single resonance (FIG. 9). On the NMR time scale, 5 should have pseudo-C₃ symmetry and therefor the benzylic CH₂ protons should not be equivalent. Indeed, the proximity of these protons to be aromatic rings may explain the ca. 1.4 ppm chemical shift difference displayed in the room temperature spectrum shown in FIG. 9. Upon heating, compound 5 assumes pseudo-C₃ᵥ symmetry on the NMR time scale and all six CH₂ protons become equivalent.

To estimate the barrier to inversion in 5, ΔG^{‡}(J/mol)=19.14T_{c}[9.97+log(T_{c}/δv)] was calculated from the coalescence temperature of the NCH₂C₆H₂ methylene protons in the ¹H NMR spectrum.¹⁶ ΔG^{‡}for 5 (at T_{c}=325 K with δv=292.66 Hz) is 62.3 KJ/mol. By contrast, the analogous benzylic protons of 6 cannot become equivalent upon ring inversion because the cage moiety of 6 is pseudo-Cₛ symmetric. The C₁-symmetric twisted solid-state structure for 6 suggested that four chemical shifts should be observed in the ¹H NMR spectrum, but only two were seen (Table 6).

TABLE 6
Comparison of ¹H chemical shifts for compounds 1-8 dissolved in CDCl₃.

| | Peak Assignment | | | | | | |
|---|---|---|---|---|---|---|---|
| Compound | aryl-H | CH₂O | CHMe₂ | NCH₂-aryl | NCH₂CH₂ | aryl-Me | CHMe₂ |
| 1 | 6.83, 6.71 | | | 3.61 | | 2.19 | |
| 2 | 6.83, 6.67 | 3.85 | | 3.71 | 2.67 | 2.18 | |
| 3 | 6.83, 6.61 | 3.73 | | 3.77 | 2.74 | 2.19 | |
| 4 | | 3.69 | | | 2.43 | | |
| 5 | 7.18-6.73 | | 4.11^{a} | 4.11^{a}, 2.97 | | 2.23, 2.06 | 1.24 |
| 6 | 7.27-6.80 | 4.53 | 4.00 | 3.91, 3.63 | 3.00 | 2.25, 2.15 | 1.29 |
| 7 | 7.07-6.81 | 4.60, 4.45 | 3.80 | 3.96 | 3.20, 3.13 | 2.25, 2.16 | 1.27 |
| 8 | 7.02, 6.84 | 4.54 | 3.62 | | 3.29 | | 1.25 |

^{a}The CHMe₂ and NCH₂-aryl proton resonances overlap.

Similar considerations hold for the NCH₂ groups of 7 for which two peaks were also observed in the ¹H NMR spectrum. (See Table 6) As observed in other 5-membered titanatranes, the protons for both sets of methylene groups of 8 should be equivalent owing to the rate of ring inversion which is rapid on the NMR time scale. Similarly, the ¹³C {¹H} NMR spectrum of 5 exhibits resonances corresponding to non-equivalent i-Pr groups even at room temperature, owing to its pseudo-Cₛ symmetry. In the ¹H NMR spectrum of 5, the two i-Pr methyl groups displayed a somewhat broadened singlet, a doublet and a triplet at room temperature in chloroforn-d₁, toluene-d₈ and benzene-d₆, respectively. However, as the temperature of the benzene-d₆ solution decreased, the triplet gradually became two doublets, which is expected for two nonequivalent i-Pr groups whose CH₃ protons are equivalent owing to rapid rotation.

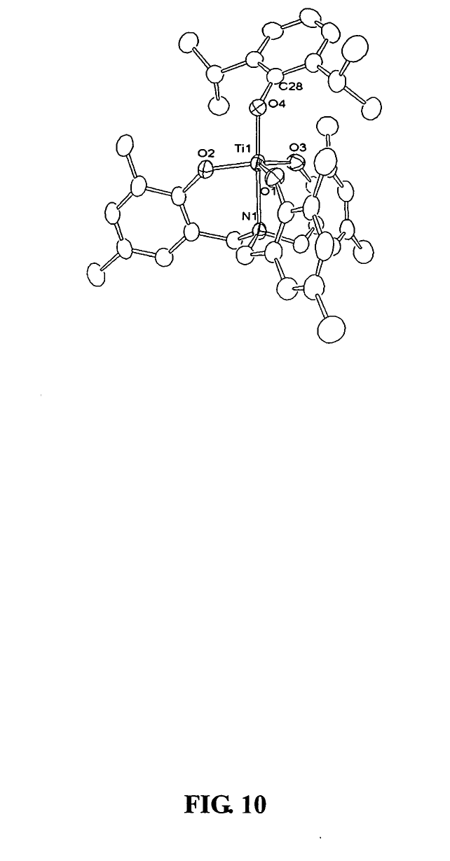

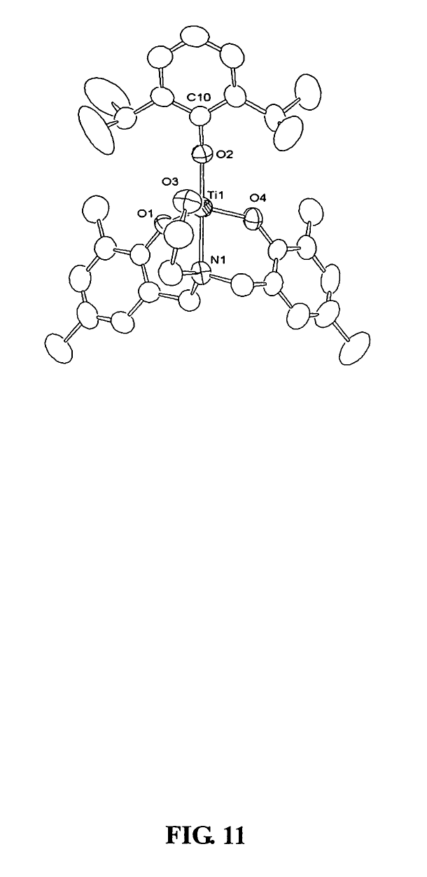

In order to elucidate the nature of the metal-ligand bonding in these titanatranes, single-crystal X-ray diffraction studies were carried out on 5 and 6. ORTEP depictions shown in FIGS. 10 and 11, respectively. Selected bond distances and selected bond angles for 5 are (Å): Ti1-O1=1.836(2), Ti1-O2=1.822(2), Ti1-O3=1.831(2), Ti1-O4=1.834(2), Ti1-N1=2.306(2). Selected bond angles (°): C28-O4-Ti1=138.52(17), O4-Ti1-N1=174.89(8), O1-Ti1-O4=100.05(9), O2-Ti1-O4=97.96(9), O3-Ti1-O4=92.93(9). Selected bond distances and selected bond angles for 6 are (Å): Ti1-O1=1.828(3), Ti1-O2=1.825(3), Ti1-O3=1.807(3), Ti1-O4=1.829(3), Ti1-N1=2.287. Selected bond angles (°): C10-O2-Ti1=145.7(3), O1-Ti1-O2=102.43(13), O2-Ti1-O3=93.68(14), O2-Ti1-O4=99.66(14), O2-Ti1-N1=170.38(13).

The X-ray analyses reveal that 5 and 6 have similar solid-state structures, and both possess 0.5 THF molecules of solvation. In contrast to oxygen-bridged dimeric structures frequently observed for titanatranes, the molecular structures of 5 and 6 are monomeric (which is consistent with their NMR spectra) presumably because of the steric bulk of the axially located di-i-Pr-phenolate ligand.

The tricyclic cage moiety of 5 resembles a 3-bladed turbine of C₃ symmetry while that in 6 is similar (with an ethylene bridge replacing an aryl methylene group) resulting in CS symmetry. In addition to the three anionic oxygens, the titanium atom in 5 and 6 is ligated via a transannular interaction stemming from the bridgehead amino nitrogen, giving a slightly distorted trigonal bipyramidal local geometry around the metal. The sum of the angles around the equatorial oxygens is 355.68(10)° and 353.54(15)° in 5 and 6, respectively. As a result, the acute O_{eq}-Ti-N angles [avg=83.07(8)° for 5 and 81.59(14)° for 6] and the obtuse O_{eq}-Ti-Oₐₓ angles [avg=96.98(9)° for 5 and 98.59(14)° for 6] reflect a displacement of the titanium atom toward the axial oxygen which is larger for 6. Furthermore, the Nₐₓ-Ti-Oₐₓ angle deviates from linearity by 5.11(8)° in 5 and by 9.62(13)° in 6. These deviations are large compared with deviations of 0.20(8)-1.46(3)° reported for other mononuclear titanatranes although values of 15.5(1) -51.05(8)° for this angle have been described for di or multinuclear oxo-bridged titanatranes. The average

Ti—O bond distance for all four oxygens in each of 5 [1.831(2) Å] and 6 [1.822(3) Å] is similar to the average of this distance observed for other structurally characterized titanatranes. Interestingly, the transannular Ti-N bond distance in 5 [2.305(2) Å] and 6 [2.287(4) Å] falls near the short end of the range of 2.264(3) to 2.400(3) Å found in previously structurally characterized titanium trialkanolamine derivatives.³

Preliminary results on the use of titanium alkoxide catalysts for the bulk polymerization of I-LA and rac-LA are summarized for 5-8 in Table 7.

TABLE 7
Data for l and rac-lactide bulk polymerizations catalyzed by 5-8.^{a}

| | Type | | | | | |
|---|---|---|---|---|---|---|
| Catalyst | of lactide | g polymer | yield (%) | M_{w}^{b} | Mₙ^{b} | PDI^{b} |
| 5 | 1-lactide | 1.38 | 69 | 29,300 | 19,400 | 1.51 |
| | rac-lactide | 1.35 | 68 | 23,000 | 16,000 | 1.43 |
| 6 | 1-lactide | 1.50 | 75 | 30,700 | 18,700 | 1.64 |
| | rac-lactide | 1.47 | 74 | 24,700 | 16,500 | 1.50 |
| 7 | 1-lactide | 1.82 | 91 | 30,800 | 20,000 | 1.56 |
| | rac-lactide | 1.79 | 90 | 32,900 | 23,100 | 1.42 |
| 8 | 1-lactide | 1.98 | 99 | 44,500 | 25,400 | 1.75 |
| | rac-lactide | 1.92 | 96 | 66,100 | 33,600 | 1.97 |

^{a}Lactide (2 g) lactide/Ti = 300, polymerization temperature = 130° C., polymerization time = 24 hr.
^{b}The weight average molecular weight (M_{w}), the number average molecular weight (Mₙ) and the polydispersity index (PDI = M_{w}/Mₙ) were determined by GPC.

It appears that the initiating group is the highly bulky di-i-Pr-phenolate group, which was shown by ¹H NMR spectroscopy to be present in solutions of the isolated polylactide samples. It is seen from Table 7 that the nature of the chelating tetradentate ligand significantly affects the molecular weight and the polydispersity indices (measured by GPC) and also the yield of the polymer. As the number of five-membered rings in the tetradentate ligand increases, there is a rough trend toward increasing polymerization activity and polydispersity index. Interestingly, catalysts 5-8 yield polymers with somewhat large polydispersities and low molecular weights. This may be attributed to a rate of initiation that is slower than the rate of polymer propagation, thus allowing more time for the occurrence of transesterification reactions during propagation. As a consequence, bimodal and unimodal molecular weight distributions exhibiting a side tail or shoulder can be encountered, as was observed in the GPC trace of several of the polymers. However, despite this problem and the fact that the polymerizations were carried out at an elevated temperature, the PLA polydispersity indices are in an acceptable range (1.42-1.97 in Table 5).

A determination of the stereochemical microstructure of PLA can be achieved upon inspection of the methine region of homonuclear decoupled ¹H NMR spectra of PLA solutions. See, for example, Thakur, K. A., et al., J. Chem. Commun. 1998, 1913 and Chishom, et al., J. Chem. Commun, 1997, 1999, both of which are hereby incorporated by reference in their entirety. Such spectra of PLA derived from rac-LA display the typical five resonances predicted from a Bemouillian analysis of totally random (atactic) PLA, whereas spectra of PLA derived from l-LA, exhibit only one peak corresponding to the mmm tetrad for isotactic PLA. ¹H NMR spectra corresponding to these descriptions were also observed for the correspondingly derived polymers.

In summary, a novel series of four titanatranes have been synthesized which feature a stepwise change in ring size from five to six-membered rings. These complexes function, with a trend in efficiency roughly paralleling the number of five-membered rings they possess, as single-site initiators for the polymerization of l-LA to isotactic PLA and rac-LA to atactic PLA.

### EXAMPLE 3

A new trinuclear titanium alkoxide 2 was synthesized according to the following method. 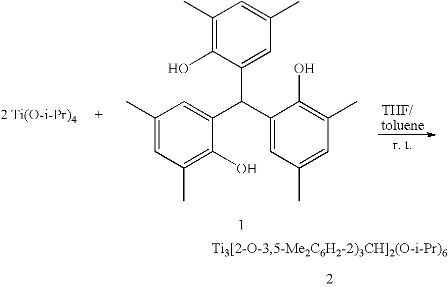
Synthesis and Discussion

Initially, a 1:1 ratio of 1 to Ti(O-i-Pr)₄ was used, but a mixture of products was obtained. The same result was realized as the ratio of Ti(O-i-Pr)₄ was increased, until the ratio of 1 to Ti(O-i-Pr)₄ reached 1:2. It is interesting to note that even when an excess of Ti(O-i-Pr)₄ was employed, only 2 was obtained as shown by the following spectra: ¹H NMR (C₆D₆, 400.147 MHz): δ 7.47 (s, 6H, aryl-H), 7.30 (s, 2H, CH-aryl), 6.83 (s, 6H, aryl-H), 4.13 (m, 6H, CHMe₂), 2.44 (s, 18H, aryl-Me), 2.18 (s, 18H, aryl-Me), 0.91 (d, J=6.1 Hz, 18H, CHMe₂), 0.79 (d, J=6.0 Hz, 18H, CHMe₂). ¹³C{¹H} NMR (C₆D₆, 100.626 MHz): δ 161.0, 137.8, 132.4, 129.0, 128.9, 127.5 (aryl), 79.96 (OCHMe₂), 37.62 (CH-aryl), 25.99 (CHMe₂), 25.58 (CHMe₂), 21.41 (aryl-Me), 18.22 (aryl-Me). Anal. Calcd for C₆₈H₉₂O₁₂Ti₃·⅓ toluene: C, 66.53; H, 7.48. Found: C, 66.90; H, 7.55.

The dropwise addition of 1 (1 g, 2.7 mmol) in 20 mL of THF to a well stirred solution of Ti(O-i-Pr)₄ (1.5 g, 5.4 mmol) in 20 mL of toluene at room temperature gave a slightly turbid solution. After stirring for 12 hours, a clear solution was obtained and then volatiles were removed under vacuum with heating of the residue to 70° C. to remove remaining volatiles. After extraction of the residue with 20 mL of toluene and filtration through a Celite pad, the filtrate was left to overnight in a refrigerator (−15° C.), resulting in the formation of clear colorless crystals (yield=39%) suitable for X-ray analysis. Complex 2 is readily soluble in a range of aromatic solvents, but only slightly in aliphatic solvents. It is slowly hydrolyzed in moist air but it is noticeably less reactive to moisture than the parent Ti(O-i-Pr)₄.

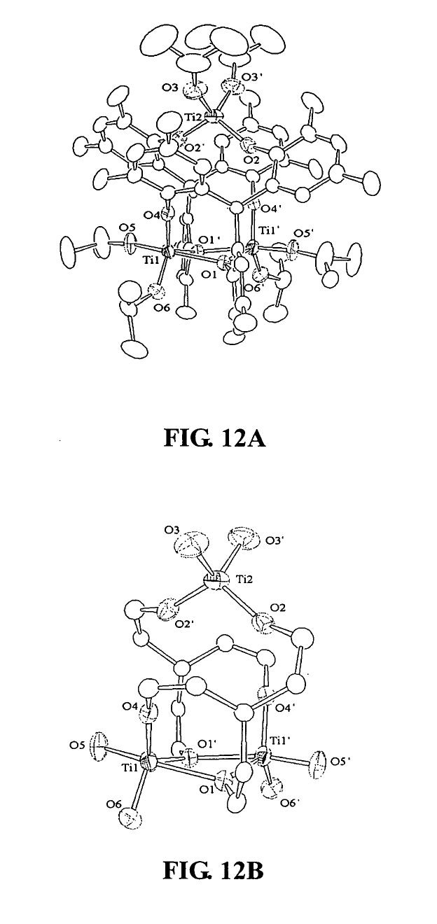

The solid state molecular structure of 2 [which is henceforth designated as “2(ss)”] depicted in FIG. 12A features a trinuclear array of titanium(IV) atoms containing as ligands two deprotonated molecules of 1, a 4-coordinate titanium atom (Ti2) and two 5-coordinate titanium centers (Ti1) and (Ti1′).

X-ray structure analysis shows: Crystal evaluation and data collection were performed at 173K on a Bruker CCD-1000 diffractometer with MoKₐ (λ=0.71073 Å) radiation with a detector-to-crystal distance of 5.03 cm. The positions of the heavy atoms were found by direct methods. The remaining non-hydrogen atoms were located in an alternating series of least-squares cycles and difference Fourier maps. All non-hydrogen atoms were refined in a full-matrix anisotropic approximation including the C30 and C31 carbon atoms disordered in two positions with occupancy factors of 0.62 and 0.38. All hydrogen atoms were placed in the structure factor calculation at idealized positions and were allowed to ride on the neighboring atoms with relative isotropic displacement coefficients. C₆₈H₉₂O₁₂Ti₃ (M=1245.12), Crystal system=Orthorhombic, Space group=Pnna, a=23.779(7) Å, b=13.776(4) Å, c=20.086(6) Å, α=β=γ=90°, V=6580(3) Å³, Z=4, d_{calc}=1.257 gcm⁻³, R1=0.0510, wR2=0.1261. Maximum and minimum heights in the final difference Fourier map are 0.299 and -0.371 eÅ⁻³.

Interestingly, the three titanium atoms are at the corners of an isosceles triangle with the bond angles of 37°, 71.5° and 71.5°, respectively. No direct Ti—Ti interactions are present because of the large Ti1-Ti1′ and Ti1-Ti2 distances [3.3742(17) Å and 5.318(2) Å, respectively]. The six isopropoxide groups are distributed equally among the three titanium atoms and none of the six isopropoxides occupy any bridging positions. In each ligand trianionic ligand derived from deprotonated 1, one of the three oxygen donors bridges each of the two 5-coordinate titanium atoms and the second and third oxygens of the ligand are bound to a 4- and a 5-cooridnate titanium atom, respectively.

Not unexpectedly, the coordination geometry around the 4-coordinate titanium atom in 2(ss) is quite tetrahedral. However, the coordination geometry around the 5-coordinate titanium atoms is considerably distorted from trigonal bipyramidal. Thus, for example, the O5-Ti1-O1 angle of 159.93(14)° is considerably smaller than the ideal value of 180°. This distortion is further verified by the sum of the angles around the psudoequatorial oxygens O1′, O4 and O6 [353.73(14)°]. Moreover, the acute O_{eq}-Ti1-O1 [av=82.36(13)°] and the obtuse O_{eq}-Ti1-O5 [av=98.58(15)°] angles reflect a small displacement of the Ti1 atom toward O5 (0.25 Å) that is outside of experimental error (i.e., 3×esd). The geometry at the Ti1′ center is similar. In spite of the aforementioned distortions, 2(ss) has a C₂ symmetric axis through Ti2 and the centroid of the Ti1-O1-Ti1′-O1′ plane that is 5.194(3) Å from Ti2. All the Ti-O(isopropoxide) and the unique Ti1-O4 and Ti2-O2 distances are near 1.80 Å (in good agreement such bond lengths observed in related structures^{4,12,15-17}). There is, however, a distinct asymmetry in the Ti₂O₂ bridged system wherein the Ti1-O1 and Ti1′-O1 distances are 2.152(3) Å and 1.970(3) Å, respectively. The TiC(isopropoxide) bond angles are unusually large (143.0(3)-171.8(5)°) presumably in order to maximize pi electron density to the metal center. This open angle facilitates the coordination of the oxygens in deprotonated 1 to more than one metal center, thus giving rise to the observed trimeric solid state structure. The relatively narrow O1-Ti1-O1′ and O1-Ti1′-O1′ bond angles [67.58(14)°] and the Ti1-O1′-Ti1′ and the Ti1-O1-Ti1′ angles for the virtually planar sp2 hybridized oxygens [109.80(14)°] appear to be a consequence of compromises reached among the oxygen and titanium atoms in accommodating the strain incurred in forming the four-membered ring.

Other structurally characterized trinuclear titanium alkoxide species have structures that are quite dissimilar from that of 2 in that linear and symmetrical triangular structures comprise the two basic frameworks observed heretofore. Triangular examples include those with three 6-coordinate Ti(IV) centers such as [Ti₃(μ₃-O)(μ₃-OMe)(μ-O-i-Pr)₃(O-i-Pr)₆] and [Ti₃O(μ-O-i-Pr)₃(O-i-Pr)₄ {Me₂C(O)CH═C(O)CH₂C(O)Me₂}]. Linear structures contain different coordination patterns for the central and terminal titanium atoms as, for example, in [Ti(O-i-Pr)₃][μ-Ti(C₆H₉O₃-O¹, O⁵)₂] which features a central 6-coordinate Ti(IV) center and two terminal 5-coordinated Ti(IV) centers whereas [Ti₃(OPh)₉(TMEDA)₂] (TMEDA=Me₂NCH₂CH₂NMe₂) includes a central 5-coordinate Ti(III) center and two terminal 6-coordinated Ti(III) centers. In addition to the unique features mentioned earlier for 2(ss), it is the first example of a trinuclear titanium complex containing only lower-coordinate (4 and 5) metal centers.

A most unusual property of 2(ss) is its rearrangement in solution in the presence of catalytic amounts of atmospheric or added moisture. The initial solution ¹H spectrum of 2 in benzene-d₆ (FIG. 12A) is not in accord with its solid state structure. Although integration of the resonances in this spectrum reveals the expected 1:3 ratio of triphenoxide protons to isopropoxide protons, all the isopropoxide groups are in identical chemical environments. Furthermore, six aromatic and six aliphatic carbon resonances are present in the ³C{¹H} NMR spectrum. The solution behavior of 2 as thus far described offers little surprise since these results are consistent with fluxionality of 2(ss) in solution. However, the static structure 2(soln) shown below was chosen for the reasons stated below. The only difference between 2(ss) and 2(ss) is the absence of bridging bonds between titanium atoms in 2(soln).

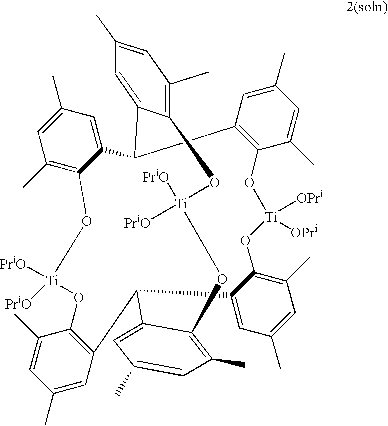

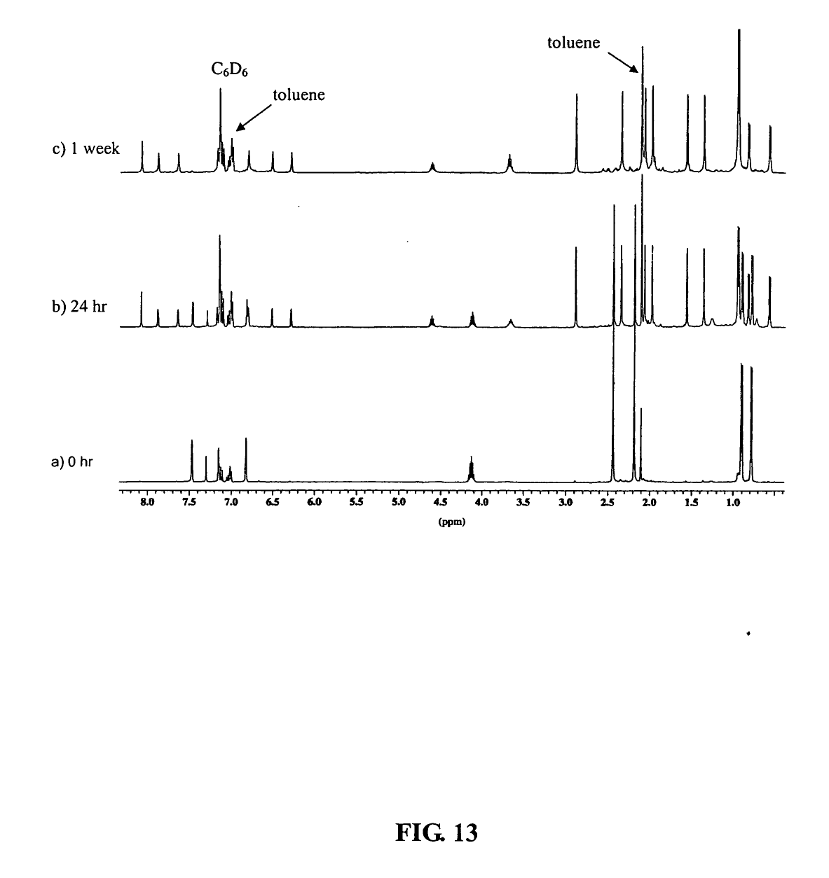

With the passage of time, new peaks appear in both the aromatic and aliphatic regions of the ¹H NMR spectrum of 2(soln) in C₆D₆, at the expense of the resonances in the initial spectrum (FIG. 13(c)). After about one week the new peaks completely dominate the spectrum and for approximately three (3) more days the spectrum does not change. After that point, however, decomposition was observed. Remarkably, the ¹H spectrum shown in FIG. 13(c) is entirely consistent with structure 2(ss) in FIGS. 12A and 12B. Thus the spectrum in FIG. 13(c) displays seven singlets (8 8.08, 7.89, 7.65, 7.17, 6.81, 6.52, 6.29) for the aryl-H and aryl-CH protons and two clearly defined septuplets (δ 4.61 and 3.68) for the OCHMe₂ protons in the expected ratio of 2:4. The OCHMe₂ methyl proton region consists of three doublets (centered at 6 0.95, 0.82 and 0.57) in the expected 24:6:6 ratio. If fluxionality on the NMR time scale were operating on 2(ss), a reversion of a fluxional spectrum to the static structure at constant temperature would not be expected.

Polymerization Procedure

Complex 2 was used as a catalyst in the ring opening polymerization of l-lactide in toluene solution at 130° C. [where the 2(soln) structure is presumed to dominate] using a [LA]/[2] ratio of 200 with [LA] =2.8 M.

Results and Discussion

TABLE 8
Solution Polymerization Data for Lactide

| | Type of | Time | Yield^{d} | Conv.^{c} | | | |
|---|---|---|---|---|---|---|---|
| Run^{a} | LA | (min) | (%) | (%) | Mw^{d} | Mn^{d} | PDI^{d} |
| 1 | l-LA | 120 | 15 | 18 | 5,700 | 4,900 | 1.15 |
| 2 | l-LA | 240 | 25 | 32 | 10,100 | 9,000 | 1.12 |
| 3 | l-LA | 300 | 30 | 40 | 12,800 | 11,400 | 1.12 |
| 4 | rac-LA | 300 | 41 | 50 | 14,000 | 12,100 | 1.16 |
| 5 | l-LA | 360 | 42 | 45 | 14,600 | 12,600 | 1.16 |
| 6 | l-LA | 390 | 45 | 53 | 17,000 | 14,900 | 1.14 |
| 7 | l-LA | 510 | 54 | 67 | 24,500 | 18,400 | 1.36 |
| 8 | l-LA | 720 | 81 | 95 | 34,300 | 25,400 | 1.35 |

Greater than 90% conversion to PLA occurred within 12 hr. Solution polymerizations of LA were carried out as follows: A stirring bar and LA were charged to a 50 mL Schlenk flask in the glove box and then the appropriate amount of toluene was added to the flask after it had been heated to 130° C. Polymerization began with the addition of 2. After the appropriate time, the reaction was terminated by the addition of 5 mL of methanol. The precipitated polymers so obtained were dissolved in a minimum amount of methylene chloride and then excess methanol was added. The resulting reprecipitated polymers were collected, washed with 3×50 mL of methanol and dried in vacuo at 50° C. for 12 hr. The ¹H and ¹³C{¹H} NMR spectra of the PLA products were recorded in CDCl₃.

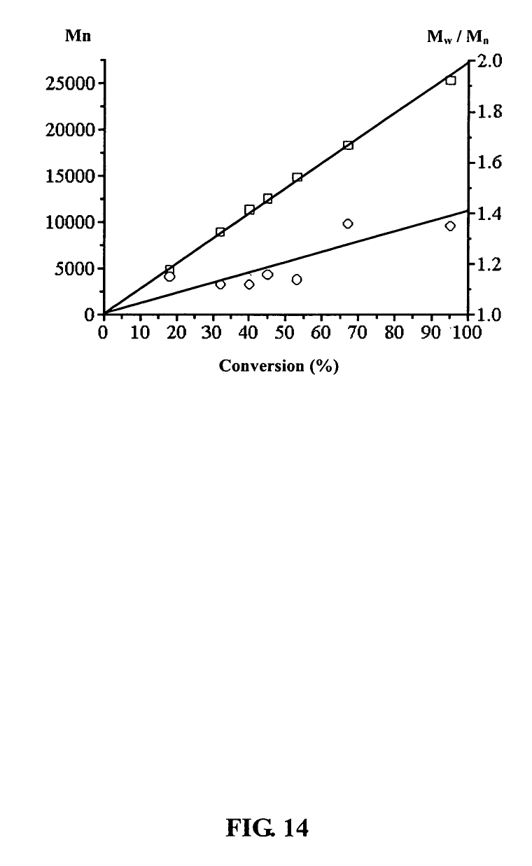

The level of polymerization control was high, as was shown by the linear increase in M, with conversion and the low polydispersity index (PDI) of the polymer produced as shown in FIG. 14. The conditions were: [lactide]/[2]=200, [lactide]=2.8 M, toluene, 130° C. However, the PDI values also increased with conversion. It is worth noting that after workup, the ¹H NMR spectrum of the PLA produced with 2(soln) shows an hydroxy as well as an i-Pr ester chain terminus, suggesting that initiation occurs through insertion of the O-i-Pr group from compound 2(soln) into LA via a coordination insertion mechanism. This is further supported by a homonuclear decoupled ¹H NMR spectrum which reveals only one resonance in the LA methine region for poly(l-LA). It is worth noting that epimerization of the chiral centers in poly(l-LA) does not occur, according to this spectrum.

### EXAMPLE 4

General Considerations

All reactions were carried out under an argon atmosphere using standard Schlenk and glove box techniques. See Shriver et al., supra. All chemicals were purchased from Aldrich and were used as supplied unless otherwise indicated. Pentane, THF and toluene (Fischer HPLC grade) were dried and purified under a nitrogen atmosphere in a Grubbs-type non-hazardous two-column solvent purification system (Innovative Technologies) and these solvents were stored over activated 3 Å molecular sieves. See Pangbom et al., sura. All deuterium solvents were dried over activated molecular sieves (3 Å) and were used after vacuum transfer to a Schlenk tube equipped with a J. Young valve. l-LA and rac-LA was twice purified by sublimation at 70° C. at 7 microns Hg before use.

¹H and ¹³C{¹H} spectra were recorded at ambient temperature on a Varian VXR-400 NMR spectrometer using standard parameters. The chemical shifts are referenced to the residual peaks of CDCl₃ (7.24 ppm, ¹H NMR; 77.0 ppm, ¹³C{¹H} NMR). Elemental analyses were performed by Desert Analytics Laboratory. The polymer molecular weights were determined by gel permeation chromatography (GPC) and the measurements were carried out at room temperature with THF as the eluent (1 mL/min) using a Waters 510 pump, a Waters 717 Plus Autosampler, four Polymer Laboratories PLgel columns (100, 500, 10⁴, 10⁵ Å) in series, and a Wyatt Optilab DSP interferometric refractometer as a detector. The columns were calibrated with polystyrene standards.

Synthesis and Discussion

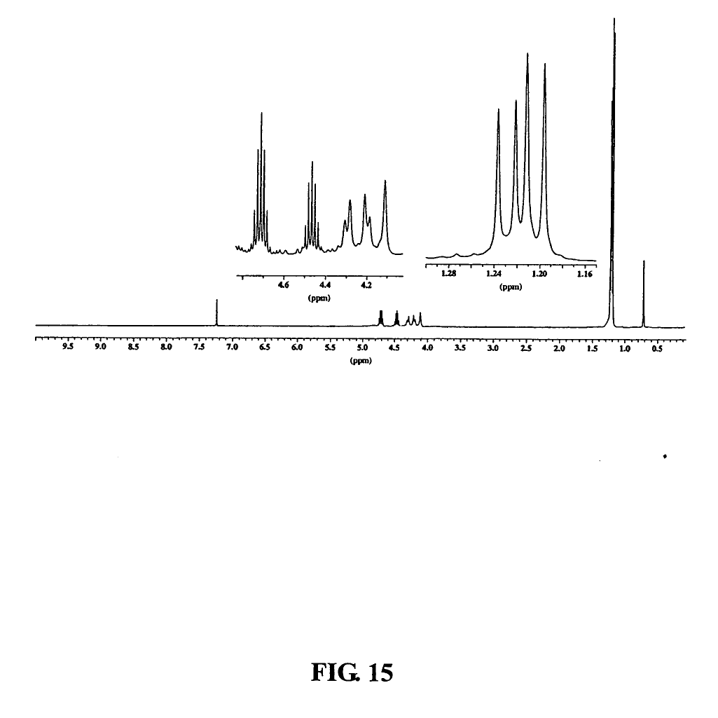

All chemicals were purchased from Aldrich. Compound 1 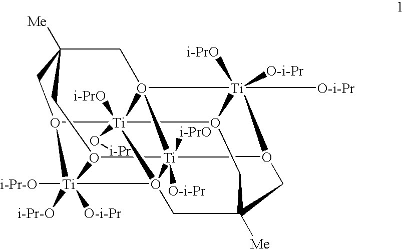
was synthesized by a modification of a procedure reported in the literature. See Boyle, et al., supra. Thus, instead of using a THF/toluene mixed solvent system, a THF was utilized instead. After successive recrystallizations, the ¹H and ¹³C{¹H} NMR data for 1 were substantially different from those in the literature values. However, the elemental analysis carried out fits well for 1. See FIG. 15.¹H NMR (CDCl₃, 400.147 MHz): δ 4.71 (sept, 6H, OCHMe₂), 4.47 (sept, 4H, OCHMe₂), 4.26 (q, J=9.6 Hz, 8H, MeC(CH₂O)₃), 4.11 (s? 4H, MeC(CH₂O)₃), 1.23 (d, J=6.0 Hz, 24H, OCHMe2), 1.205 (d, J=6.1 Hz, 36H, OCHMe2), 0.72 (s, 6H, MeC(CH₂O)₃). ¹³C{¹H} NMR (CDCl₃, 100.626 MHz): δ 80.92, 79.55 (MeC(CH₂O)₃), 77.41, 76.20 (OCEMe₂), 46.76 (MeC(CH₂O)₃), 26.56, 26.39(OCHMe2), 15.41 (MeC(CH₂O)₃). Elemental Anal. Calcd for C₄₀H₈₈O₁₆Ti₄: C, 47.26; H, 8.73. Found C, 47.31; H, 8.90.

The literature NMR spectral values are given here for comparison: ¹H NMR (C₇D₈, 250 MHz): δ 5.03 (2H, sept, OCHMe₂), 4.55, 4.47 (7H, m, OCHMe₂, (OCH₂)₃CMe), 1.44 (42H, d, J=6.15Hz, OCHMe₂),l.38 (12H, d, J=6.18Hz, OCHMe2), 1.31 (6H, d, J=6.07 Hz, OCHMe₂), 1.25 (26H, d, J=6.07Hz, OCHMe₂), 0.540 (6H, s, (OCH₂)₃CMe). ¹³C NMR (C₇D₈, APT [attached proton test]): 8 80.0 (OCHMe₂), 79.3 (OCHMe₂), 78.8 (OCHMe₂), 72.2 (OCHMe₂), 71.2 (OCHMe₂), 71.0 (OCHMe₂), 70.8 (OCHMe₂), 37.5 (MeC(CH₂O)₃), 28.2 (OCHMe₂), 27.5 (OCHMe₂), 26.4 (OCHMe₂), 26.2 (OCHMe₂), 16.8 (MeC(CH₂O)₃).

Polymerization Procedure

LA bulk polymerizations were carried out as follows: A stirring bar, 2.00 g of LA followed by the appropriate amount of catalyst precursor was charged to a 10 mL Schlenk flask. The flask was then immersed in an oil bath at 130° C. After the appropriate time, the reaction was terminated by the addition of 5 mL of methanol. The polymers so obtained as precipitates were dissolved in a minimum amount of methylene chloride and then excess methanol was added. The resulting reprecipitated polymers were collected, washed with 3×50 mL of methanol and dried in vacuo at 50° C. for 12 hr.

Solution polymerizations of LA were carried out as follows: A stirring bar and LA were charged to a 50 mL Schlenk flask in the glove box and then the appropriate amount of toluene was added to the flask after it had been heated to the desired polymerization temperature. Polymerization began with the addition of a stock solution of the titanium compound. After the appropriate time, the reaction was terminated by the addition of 5 mL of methanol. The precipitated polymers so obtained were dissolved in a minimum amount of methylene chloride and then excess methanol was added. The resulting reprecipitated polymers were collected, washed with 3×50 mL of methanol and dried in vacuo at 50° C. for 12 hr. The ¹H and ¹³C{¹H} NMR spectra of the PLA products were recorded in CDCl₃.

Results and Discussion

Compound 1 was synthesized (with the aforementioned slight modification of the literature procedure) according to reaction 1. However, the ¹H and ¹³C {¹H} NMR spectra for 1 obtained by us after successive recrystallizations were substantially different and much simpler than the literature spectra. The ¹H NMR spectrum of crystals of 1 dissolved in CDCl₃ (shown in FIG. 14) displays two clearly defined septuplets in the downfield region (8 4.71 and 4.47) for the OCHMe₂ groups in a ratio of 6:4, and one AB quartet (6 4.31, 4.28, 4.21, 4.19) and a singlet (6 4.11) for the MeC(CH₂O)₃ substituents further upfield in a ratio of 8:4. The OCHMe₂ methyl region consists of two doublets (centered at 6 1.23 and 1.205) in a 24:36 ratio and a singlet that has been assigned to the methyl peak of MeC(CH₂O)₃ at 0.72 ppm. These NMR chemical shift assignments and integral ratios are very consistent with the reported X-ray structure, an idealized representation of which is depicted in the Introduction. Table 9 shows the comparison of the NMR data for compound 1 to those in the literature in which it was asserted that a higher number of total protons seemed to be present in the sample as well as unexpectedly low integrations for the OCHMe₂ and MeC(CH₂O)₃ protons.

TABLE 9
Comparison of ¹H NMR peaks and integrations for 1.

| | | | | | total number |
|---|---|---|---|---|---|
| | OCHMe₂ | MeC(CH₂O)₃ | OCHMe₂ | MeC(CH₂O)₃ | of protons |
| literature | 5.03 (sept, 2H) | 4.47 (m, 7H) | 1.44 (d, 42H) 1.38 (d, 12H) | 0.54 (6H) | 101 H |
| values^{[10]} | 4.55 (m) | | 1.31 (d, 6H) 1.25 (d, 26H) | | |
| this work | 4.71 (sept, 6H) | 4.26 (q, 8H) | 1.23 (d, 24H) | 0.72 (s, 6H) | 88 H |
| | 4.47 (sept, 4H) | 4.11 (s, 4H) | 1.205 (d, 36H) | | |

| | |
|---|---|
| | (1) |
| 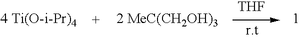 | |

Compound 1 was chosen as a catalyst for the polymerization of LA for a number of reasons: First, 1 contains ten O-i-Pr groups, one or more of which could act as an initiator for producing iso-propoxy terminated PLA. Many known multinuclear titanium complexes contain more than one type of alkoxy or aryloxy group (e.g., OR and OR′ or OAr and OAr′) in their structures. Secondly, 1 is readily soluble in toluene, a solvent commonly used in LA polymerization, whereas many homoleptic compounds of the type Tiₓ(OR)_{y} and oxo-bridged alkoxides of the type TiₓO_{y}(OR)_{z} exhibit poor solubility in standard organic solvents. Third, 1 is stable in the solid state and in toluene at ambient temperature over an extended period of time, although it is thermally unstable in toluene at elevated temperatures. Previously, it was found that the rate of initiation of LA polymerization by titanium compounds was slower than their rate of propagation. It was anticipated that the thermal instability of 1 could play a role in enhancing the initiation rate during polymerization. Finally, 1 is produced when one equivalent of 1,1,1-tris(hydroxymethyl)ethane and excess Ti(O-i-Pr)₄ was mixed in THF solution. Thus, formation of 1 appears to be kinetically and thermodynamically favored in this reaction, whereas the compositions of other homoleptic titanium cluster compounds are sensitive to the ratios of the starting materials.^{[10, 13-15]}

Before investigating the ability of 1 to facilitate controlled LA polymerization in solution, 1 was examined as a catalyst for the bulk polymerization of LA. These polymerizations were performed at 130° C. with a [LA]/[Ti] ratio of 300 and the results are summarized in Table 10, entries 1-3.

TABLE 10
Polymerization Data for LA in the Presence of 1.

| | type of | type of | | T | time | | yield | | | |
|---|---|---|---|---|---|---|---|---|---|---|
| entry | polym. | LA | LA/Ti | (° C.) | (hr) | g polymer | (%) | M_{w}^{d} | Mₙ^{d} | PDI^{d} |
| 1 | bulk^{a} | l-LA | 300 | 130 | 0.5 | 1.87 | 94 | 24,700 | 13,300 | 1.86 |
| 2 | bulk^{a} | rac-LA | 300 | 130 | 0.5 | 1.83 | 92 | 18,400 | 11,900 | 1.55 |
| 3 | bulk^{a} | l-LA | 300 | 130 | 12 | 1.98 | 99 | 34,900 | 15,000 | 2.33 |
| 4 | solution^{b} | l-LA | 100 | r.t. | 24 | 0.25 | 13 | 3,500 | 3,400 | 1.05 |
| 5 | solution^{b} | l-LA | 100 | 70 | 24 | 1.54 | 77 | 8,100 | 6,100 | 1.33 |
| 6 | solution^{b} | l-LA | 200 | 70 | 24 | 1.71 | 86 | 13,300 | 9,100 | 1.46 |
| 7 | solution^{b} | l-LA | 300 | 70 | 24 | 1.86 | 93 | 17,000 | 11,300 | 1.50 |
| 8 | solution^{b} | l-LA | 400 | 70 | 24 | 1.97 | 99 | 20,700 | 13,600 | 1.52 |
| 9 | solution^{b} | rac-LA | 100 | 70 | 24 | 1.50 | 75 | 8,800 | 7,200 | 1.22 |
| 10 | solution^{c} | l-LA | 100 | 130 | 24 | 1.39 | 70 | 15,000 | 9,800 | 1.54 |
| 11 | solution^{c} | rac-LA | 100 | 130 | 24 | 1.26 | 63 | 9,500 | 7,500 | 1.27 |

^{a}Polymerization conditions: 2 g of lactide, [LA]/[P] = 300.
^{b}Polymerization conditions: 2 g of lactide, [LA]/[P] = 300, toluene 30 mL.
^{c}Polymerization conditions: 2 g of lactide, [LA]/[P] = 300, toluene 40 mL
^{d}Weight average molecular weight (M_{w}), number average molecular weight (Mₙ) and PDI (M_{w}/Mₙ) were determined by GPC.

The data in these entries reveal that 1 was an effective catalyst for LA polymerization. Within 30 min, the conversion was nearly 100% complete and the polymer yields ranged from 92-99%. The end group of the PLA obtained with 1 is the O-i-Pr ester unit as was shown by ¹H NMR spectroscopy. Initiation is believed to occur through the insertion of an O-i-Pr group of 1 into l-LA or rac-LA, consistent with a polymerization that proceeds via a coordination-insertion mechanism. This assertion is supported by homonuclear decoupled ¹H NMR spectra of the PLA products. Such spectra of PLA derived from rac-LA display the expected characteristic five-methine resonances, whereas spectra of PLA derived from l-LA, exhibit only one methine peak. However, it is thought that a certain degree of transesterification occurred during bulk polymerization, since the PDI values of the resulting PLA were considerably higher than those expected for a controlled polymerization (i.e., PDI^{˜}1). Importantly, the lengthy polymerization times are likely to be responsible for the change from a unimodal GPC trace to multimodal one (Table 10, entry 3). This indicates that 1 is thermally unstable (as noted previously) and that this catalyst probably generates multiple initiating species during extended polymerization times.

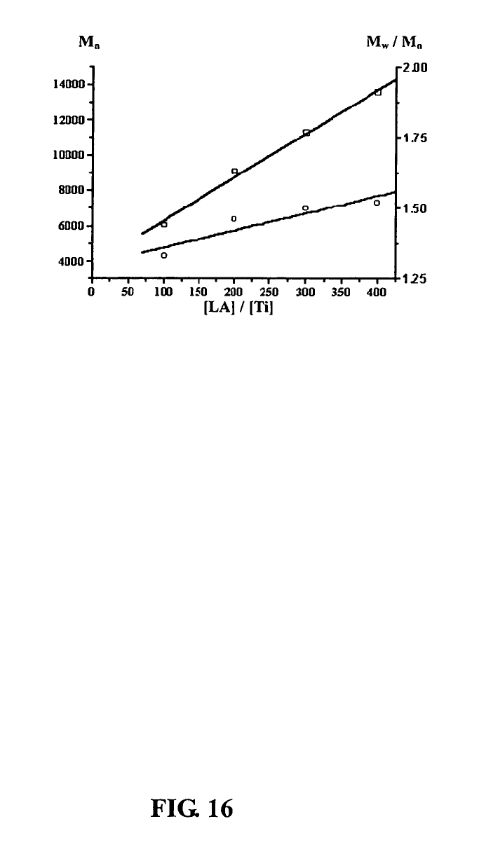

To avoid decomposition of 1 and concomitant formation of multiple initiating species at elevated temperatures, solution polymerizations of LA at room temperature were carried out. Table 10, entry 4 shows that 1 polymerizes LA in a controlled manner at room temperature. Despite the long reaction time, however, the polymer yield and molecular weight is very low owing to poor solubility of the monomer and polymer at this relatively low temperature. Raising the solution polymerization temperature to 70° C. or to 130° C. (Table 10) reveals that the molecular weights and PDI values for poly(l-LA) increased (Table 10, entries 4, 5 and 10), while the polymerization rate of rac-LA was insensitive to such a temperature increase for reasons that are not clear (entries 9 and 11 in Table 10). Interestingly, the PDI values of PLA made with 1 (which range from 1.33 to 1.55) rise quite linearly with the number average molecular weight (Mn) and the [LA]/[Ti] ratio (FIG. 16, Table 11, entries 5-8). This implies that the polymerization process is a reasonably controlled one. In addition, the linearity of the slope in FIG. 2 indicates that all isopropoxide groups in 1 could be active in the initiation step. The high “y” intercepts observed for the lines in FIG. 16 can be ascribed to a tendency for 1 to engage in intramolecular transesterification reactions in solution as well as in bulk polymerization reactions, as has been observed previously for an iron alkoxide-catalyzed LA polymerization. A low initiation efficiency and the presence of small amounts of impurities can also play roles in promoting transesterification.

It is worth noting that the ¹H NMR spectrum of PLA produced by 1 in solution shows a hydroxy as well as an i-Pr ester chain terminus, suggesting that initiation occurs through insertion of the O-i-Pr group from compound 1 into LA. This is further supported by a homonuclear decoupled ¹H NMR spectrum which reveals only one resonance and five resonances in the lactide methine region for poly(l-LA) and poly(rac-LA), respectively. Furthermore, epimerization of the chiral centers in poly(l-LA) does not occur, according to homonuclear decoupled ¹H NMR spectra of the methine region. This could mean that not only transesterification, but also cyclization and back biting probably occurs during polymerization.

Conclusion

The present invention provides many examples of titanium alkoxides that can be used to polymerize cyclic esters. The enriching of the metal electron in order to make departure of an alkoxides anion easier, whether with the caged or non-caged compounds provides a novel approach to providing effective catalysts for polymerization of cyclic esters in both bulk and solution polymerization. It is now possible to produce effective single site titanium catalysts through chelation with electron rich chelating donor ligands containing alkoxide oxygen and/or amide nitrogen donor atoms, both of which are considered “hard” electron donating ligands compatible with Ti(IV) (itself a “hard” Lewis acid”), as compared with “soft” donating ligands that may further be incapable of chelating (e.g., SR₂, TeR₂ wherein R is an alkyl group such as methyl, ethyl or isopropyl ) that would not be compatible with a material such as Ti(IV). It is also possible to use metals other than titanium, including but not limited to the metals of Groups 4 and 6-12.

Although the present invention has been described in considerable detail with reference to certain preferred versions thereof, other versions are possible. For example, although the discussion herein refers predominantly to polymerizing a single cyclic ester, in other embodiments two or more cyclic esters can be polymerized to produce a copolymer. It is also possible that some of the compounds described herein may function as catalysts for the polymerization of alkenes. Therefore, the spirit and scope of the appended claims should not be limited to the description of the preferred embodiments contained herein.

1. A catalyst comprising a titanium alkoxide for use in cyclic ester polymerization.

2. The catalyst of claim 1 wherein the cyclic ester polymerization produces an isotactic polyester.

3. The catalyst of claim 1 wherein the cyclic ester polymerization produces a heterotactic polyester or atactic polyester.

4. The catalyst of claim 1 wherein the catalyst is a non-caged titanium alkoxide.

5. The catalyst of claim 4 wherein the titanium is titanium(IV).

6. The catalyst of claim 5 wherein the catalyst is titanium(IV) tetrakis-isopropoxide, chlorotitanium(IV) tris-isopropoxide, dichlorotitanium(IV) bis-isopropoxide or combinations thereof.

7. The catalyst of claim 5 wherein the catalyst is trichlorotitanium(IV) isopropoxide having three chlorine groups.

8. The catalyst of claim 7 wherein one chlorine group is replaced with one amido group or two chlorine groups are replaced with two amido groups or three chlorine groups are replaced with three amido groups, the one to three amido groups each comprising NRR′ wherein R and R′ are selected from the group consisting of H, C₁-C₁₆, cyclics, substituted cyclics and combinations thereof.

9. The catalyst of claim 7 wherein one chlorine group is replaced with one alkoxy group or two chlorine groups are replaced with two alkoxy groups or three chlorine groups are replaced with three alkoxy groups, the one to three alkoxy groups each comprising OR wherein R is selected from the group consisting of H, C₁-C₁₆, cylics, substituted cyclics and combinations thereof.

10. The catalyst of claim 7 wherein one chlorine group is replaced with one tridentate amido ligand or two chlorine groups are replaced with two tridentate amido ligands or three chlorine groups are replaced with three tridentate amido ligand.

11. The catalyst of claim 10 wherein each of the one to three tridentate amido ligands comprises RC(CH₂NR′)₃ wherein R and R′ are selected from the group consisting of H, C₁-C₁₆, cyclics, substituted cyclics and combinations thereof.

12. The catalyst of claim 7 wherein one chlorine group is replaced with one tridentate alkoxy ligand or two chlorine groups are replaced with two tridentate alkoxy ligands or three chlorine groups are replaced with three tridentate alkoxy ligands, each of the one to three alkoxy tridentate ligands comprising RC(CH₂0)₃ wherein R is selected from the group consisting of H, C₁-C₁₆, cyclics, substituted cyclics and combinations thereof.

13. The catalyst of claim 4 wherein the catalyst contains a C₅H₅ ring, two chlorines, and a methoxide or isopropoxide.

14. The catalyst of claim 4 wherein the catalyst contains a C₅H₅ ring and three isopropoxide groups.

15. The catalyst of claim 14 wherein the catalyst is a single site catalyst.

16. The catalyst of claim 14 wherein the catalyst is cyclopentadienyltitanium(IV) tris-isopropoxide.

17. The catalyst of claim 16 wherein the cyclopentadienyltitanium(IV) tris-isopropoxide contains a C₅H₅ ring, the C₅H₅ ring having one to five R groups attached, wherein R is selected from the group consisting of H and C₁-C₅.

18. The catalyst of claim 17 wherein the catalyst contains at least one electron density donor.

19. The catalyst of claim 18 wherein the catalyst contains one or two electron density donors.

20. The catalyst of claim 19 wherein the one or two electron density donors are chloride, at least one amido group, bidentate O(CR₂)ₓO group wherein x=2 or 3 and R is H, C₁- C₅, one or more aryl groups, or combinations thereof.

21. The catalyst of claim 20 wherein the at least one amido group comprises two amido groups connected to form a chelate ring.

22. The catalyst of claim 20 wherein the cyclopentadienyltitanium(IV) tris-isopropoxide contains a C₅H₅ ring, the C₅H₅ ring having one to five R groups attached wherein R is H, C₁- C₅, one or more aryl groups, or combinations thereof.

23. The catalyst of claim 1 wherein the titanium alkoxide is a caged titanium alkoxide.

24. The catalyst of claim 23 wherein the caged titanium alkoxide is a caged titanium(IV) alkoxide containing at least one 6-membered ring, at least one 5-membered ring or combinations thereof.

25. The catalyst of claim 24 wherein the at least 6-membered ring is comprised of a benzyl or substituted benzyl ring, a titanium (IV) in combination with a nitrogen or oxygen.

26. The catalyst of claim 23 wherein the caged titanium alkoxide is an atrane or non-atrane.

27. The catalyst of claim 26 wherein the atrane is a titanatrane.

28. The catalyst of claim 27 wherein the titanatrane is an expanded ring titanatrane or partially expanded titanatrane ring.

29. The catalyst of claim 28 wherein the expanded ring titanatrane has at least one alkoxy group attached.

30. The catalyst of claim 29 wherein the expanded ring titanatrane further contains a benzyl ring having a methylene group or a substituted benzyl ring having a methylene group, the benzyl ring or substituted benzyl ring further having first R group attached, wherein R is H, C₁-C₅, one or more aryl groups, or combinations thereof.

31. The catalyst of claim 30 having a second R group connected to the methylene group, wherein the second R is H, C₁-C₅, one or more aryl groups, or combinations thereof.

32. The catalyst of claim 28 wherein the catalyst is 2,2′2″-nitrilo-tris(2-methylenyl-4,6-dimethylphenolato)titanium isopropoxide or 2,2′2″-nitrilo-tris(2-methylenyl4-methyl-6-tertiarybutylphenolato)titanium isopropoxide.

33. A compound comprising 2,2′2″-nitrilo-tris(2-methylenyl4-methyl-6-tertiarybutylphenolato)titanium isopropoxide.

34. The catalyst of claim 27 wherein the titanatrane contains at least one axial substituent.

35. The catalyst of claim 34 wherein the at least one axial substituent is an alkoxy group.

36. The catalyst of claim 35 wherein the titanatrane is an isopropoxy derivative.

37. The catalyst of claim 36 wherein the isopropoxy derivative is isopropoxytitanatrane.

38. The catalyst of claim 26 wherein the atrane is a combination of titanatranes.

39. The catalyst of claim 38 wherein the atrane comprises a pinacolyxloxy compound attached to each of two titanatranes.

40. The catalyst of claim 39 wherein the atrane is pinacolyloxy-bis-titanatrane.

41. The catalyst of claim 27 wherein the titanatrane contains a fused second ring structure connected to an oxygen atom, the oxygen atom connected to a titanium atom.

42. The catalyst of claim 41 wherein the fused second ring structure is a benzyl ring or substituted benzyl ring with an R group, wherein R is H, C₁-C₅ or an aryl group and is connected to the benzyl ring or substituted benzyl ring at any location, wherein the benzyl ring or substituted benzyl ring is connected to an oxygen atom, the oxygen atom connected to a titanium atom.

43. The catalyst of claim 27 wherein the titanatrane includes more than one benzene ring.

44. The catalyst of claim 43 including three benzene rings.

45. The catalyst of claim 44 wherein the titanatrane is 2,2′,2″-nitrilotriphenolato)titanium isopropoxide.

46. A compound comprising a caged alkoxide titanium titanatrane having an nitrilo-tris-(aryloxy) group.

47. The compound of claim 46 wherein the nitrilo-tris-(aryloxy) group is a phenyl group

48. The compound of claim 46 wherein the nitrilo-tris-(aryloxy) group possesses an electron withdrawing group or electron neutral group.

49. The compound of claim 48 wherein the nitrilo-tris-(aryloxy) group is a phenoxy group.

50. The compound of claim 49 wherein the titanatrane is phenoxytitanatrane, tetrafluorophenoxytitanatrane, paranitrophenoxytitanatrane or 2,4,6-trimethylphenoxytitanatrane.

51. A catalyst comprising the compound of claim 46 for use in cyclic ester polymerization.

52. A catalyst comprising the compounds of claim 50 for use in cyclic ester polymerization.

53. A compound comprising 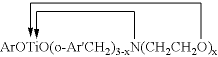
wherein Ar=2,6-di-i-Pr-phenoxy, Ar′=2,4-di-MeC₆H₂ and x=0-3.

54. The compound of claim 53 comprising one to three 6-membered chelating rings or one to three 5-membered chelating rings.

55. The compound of claim 54 wherein at least one of the one to three 5-membered chelating rings is a titanatrane.

56. The compound of claim 55 wherein the titanatrane is nitrilotriethoxytitanatrane.

57. The compound of claim 54 wherein the titanatrane is an expanded ring titanatrane or partially expanded ring titanatrane.

58. The compound of claim 57 wherein the partially expanded ring titanatrane is a ⅓ expanded ring or ⅔ expanded ring titanatrane.

59. The compound of claim 57 wherein the titanatrane is nitrilo-tris(2-hydroxy-3,5-dimethylbenzyl)titanatrane, nitrilo-bis(2-hydroxy-3,5-dimethylbenzyl)ethoxytitanatrane or nitrilo-(2-hydroxy-3,5-dimethylbenzyl)diethoxytitanatrane.

60. A catalyst comprising the compound of claim 53 for use in cyclic ester polymerization.

61. A catalyst comprising the compounds of claim 59 for use in cyclic ester polymerization.

62. A compound comprising a trinuclear titanium alkoxide comprising:
two sets of benzene rings, each set of benzene rings containing three benzene rings, wherein each of the three benzene rings in each set is connected to a methine carbon;
a pair of tris(2-oxyphenyl)methane groups containing the two sets of benzene rings, wherein one or both of the tris(2-oxyphenyl)methane groups can be substituted with alkyl or aryl groups on the benzene rings or on one or more of the methine carbons; and
six alkoxy groups attached to the two sets of benzene rings.

63. The compound of claim 62 wherein the six alkoxy groups are selected from the group consisting of a a methoxy group, an ethoxy group, a propoxy group, a butoxy group and a pentoxy group.

64. The compound of claim 62 wherein the compound is Ti₃[tris(2-oxy-3,5 dimethylphenyl)methane]₂(O-i-Pr)6.

65. A catalyst comprising the compound of claim 64 for use in cyclic ester polymerization.

66. A compound comprising a tetranuclear titanium alkoxide comprising:
two RC(CR′₂O)₃ groups, wherein R and R′ are H, C₁-C₅, one or more aryl groups or combinations thereof; and ten OR″ groups, wherein R″ is one or more alkoxy groups.

67. The compound of claim 66 wherein each of the six alkoxy groups are selected from the group consisting of a methoxy group, an ethoxy group, a propoxy group, a butoxy group and a pentoxy group.

68. The compound of claim 66 wherein the compound is bis1,1,1-trimethylene-oxyethane deca-isopropoxy tetratitanium.

69. A catalyst comprising the compound of claim 66 for use in cyclic ester polymerization.

70. A catalyst comprising the compound of claim 68 for use in cyclic ester polymerization.

71. A catalyst comprising an atrane or expanded ring atrane of metals of Group 4and6-12.

72. The catalyst of claim 71 wherein the catalyst is used in a cyclic ester polymerization.

73. The catalyst of claim 71 wherein the catalyst is selected from the group consisting of 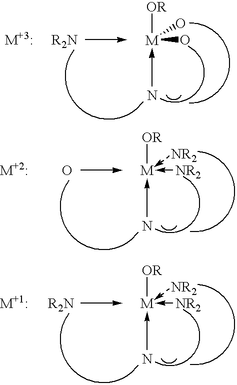
and combinations thereof.

74. The catalyst of claim 73 wherein the catalyst possesses chirality, wherein chirality is induced in polyester polymers made from chiral cyclic esters.

75. The catalyst of claim 71 wherein the catalyst is selected from the group consisting of 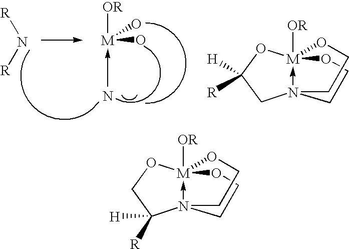
and combinations thereof.

76. A method comprising:
polymerizing a cyclic ester in the presence of a titanium alkoxide catalyst under effective polymerization conditions to produce a polymerized cyclic ester.

77. The method of claim 76 wherein the catalyst is a caged titanium alkoxide.

78. The method of claim 76 wherein the catalyst is a non-caged titanium alkoxide.

79. The method of claim 78 wherein the titanium is titanium(IV).

80. The method of claim 78 wherein bulk polymerization is used.

81. The method of claim 80 wherein the bulk polymerization occurs in temperatures ranging from about zero (0) to 200° C.

82. The method of claim 78 wherein solution polymerization is used.

83. The method of claim 82 wherein the solution polymerization utilizes a solvent having a boiling point.

84. The method of claim 83 wherein the solvent is selected from the group consisting of toluene, methylene chloride, tetrahydrofuran, and combinations thereof.

85. The method of claim 84 wherein the solution polymerization occurs in temperatures ranging from about zero (0) ° C. up to the boiling point of the solvent.

86. The method of claim 78 wherein suspension polymerization or emulsion polymerization is used.

87. The method of claim 78 wherein the polymerized cyclic ester is an isotactic cyclic ester.

88. The method of claim 78 wherein the polymerized cyclic ester is a heterotactic or atactic cyclic ester.

89. A method for making 2,2′2″-nitrilo-tris(2-methylenyl-4-methyl-6-tertiarybutylphenolato)titanium isopropoxide comprising:
combining titanium tetrakis-isopropoxide with trihydroxylbenzylamine (THBA) in the presence of a first solvent to produce a mixture;
removing the solvent to produce a residue;
re-crystallizing the residue to produce 2,2′2″-nitrilo-tris(2-methylenyl-4-methyl-6-tertiarybutylphenolato)titanium isopropoxide.

90. The method of claim 89 wherein the first solvent is discloromethane.

91. The method of claim 90 further comprising stirring the mixture at room temperature for at least about 10 minutes.

92. The method of claim 91 wherein the mixture is stirred for an additional 12 to 16 hours.

93. The method of claim 92 further comprising washing the crystalline product with a second solvent to produce a washed crystalline product and drying the washed crystalline product prior to recrystallization.

94. A method for making Ti₃[tris(2-oxy-3,5 dimethylphenyl)methane]₂(O-i-Pr)₆ comprising:

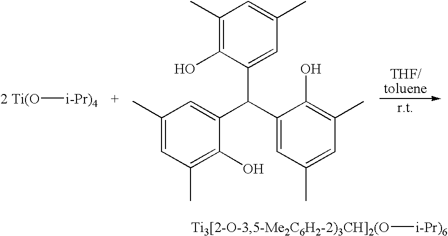

95. The catalyst of claim 1 wherein lactide (LA) or e-caprolactone is used in the cyclic ester polymerization.

96. The method of claim 76 wherein the cyclic ester is lactide (LA) or e-caprolactone.
